(19) United States
(12) Patent Application Publication
(10) Pub. No.: US 2025/0330625 A1
(43) Pub. Date: Oct. 23, 2025

(54) SYSTEM AND METHOD FOR DETERMINING DOSAGE OF COFFEE GROUNDS INTO A PORTAFILTER

(71) Applicant: Breville Pty Limited, Alexandria NSW (AU)

(72) Inventors: Tae-kyung KONG, Alexandria NSW (AU); Bryce James GOSSLING, Alexandria NSW (AU); Giovanni BAEZ ALVAREZ, Alexandria NSW (AU); Norman OLIVERIA, Alexandria NSW (AU); Anthony LADEWIG, Alexandria NSW (AU); Chiu Keung Kenneth LEE, Alexandria NSW (AU); Mark Lewis HOLLOWAY, Alexandria NSW (AU)

(21) Appl. No.: 19/201,083

(22) Filed: May 7, 2025

Related U.S. Application Data
(63) Continuation of application No. 18/268,898, filed on Jun. 21, 2023.

(30) Foreign Application Priority Data
Dec. 23, 2020 (AU) 2020904817
Aug. 25, 2021 (AU) 2021221718

(51) Int. Cl. H04N 19/44; A47J 31/40; A47J 31/42; A47J 31/44; A47J 31/52; A47J 42/40; H04N 19/119; H04N 19/159; H04N 19/176

(52) U.S. Cl. CPC H04N 19/44; A47J 31/404; A47J 31/42; A47J 31/446; A47J 31/525; A47J 42/40; H04N 19/119; H04N 19/159; H04N 19/176; A47J 31/4403

(57) ABSTRACT

A method of delivering coffee grounds into a portafilter fitted to a machine for grinding coffee including determining a pre-determined grind to provide the coffee grounds, applying a tamp to form the coffee grounds into a puck, and providing tamp position feedback to a user during and/or after a tamping operation. The invention also relates to a system for implementing the method.

### RELATED APPLICATIONS

This application claims priority from Australian Patent Application Number AU2020904817 and Australian Patent Application AU2021221718, the contents of which are incorporated by reference.

### FIELD

The present invention relates to a system and method for determining dosage of coffee grounds into a portafilter.

### BACKGROUND

A coffee machine generally has a grinder for grinding coffee beans and a grinder chute to convey the ground coffee to a portafilter fitted into a portafilter holder of the machine, where the coffee is tamped into a puck by a tamper, prior to injection of steam and/or water which filters through the puck and is extracted into a cup positioned beneath the portafilter.

Consistency of puck preparation is important for consistent extraction. This requires an even distribution of grounds, consistent tamping pressure for each puck and dosage amount of coffee grounds among other variables.

### SUMMARY OF THE INVENTION

In one aspect, there is provided a method of delivering coffee grounds into a portafilter fitted to a machine for grinding coffee including determining a pre-determined grind to provide the coffee grounds, applying a tamp to form the coffee grounds into a puck, and providing tamp position feedback to a user during and/or after a tamping operation.

In one embodiment, the method includes monitoring tamp depth.

In one embodiment, the method includes informing the user if any adjustment to the grind is needed.

In one embodiment, the method further includes determining if the tamp depth is within a predetermined tolerance and adjusting a grind time if the tamp depth is outside the pre-determined tolerance.

In one embodiment, the method further includes determining deviation of the tamp depth, if outside the pre-determined tolerance, providing information to a user through a user interface of tamp depth deviation, together with deviation polarity.

In one embodiment, the method further includes providing user prompts through the user interface to adjust grind time manually.

In one embodiment, the method further includes monitoring a status of a hopper, grinder motor and portafilter and turning the grinder off if the hopper is empty, the grinder is blocked or the portafilter is not present.

In one embodiment, the method further includes recording the actual grind time if the grinder motor is turned off and updating the grind time for a subsequent grind to include a time required to complete a grinding operation when the grinder is again turned on.

In one embodiment, the method further includes notifying a user of the hopper, grinder motor and portafilter status through a user interface and notifying the user of the updated grind time.

In one embodiment, the method further includes determining if an incorrect basket size has been selected by the user by measuring the tamp depth to assess if the tamp depth is in a range that correlates with an expected tamp depth for the selected basket size.

In one embodiment, the method further includes notifying a user through the user interface if the determination is an incorrect basket size has been entered by the user and updating the grind time to reflect a correct basket size selection.

In one embodiment, the method further includes calibrating the machine using pucks of known heights set to the pre-determined tolerances, conducting a tamping operation and checking if the tamp position correlates to the known puck heights and making any calibration adjustments, if needed.

In one embodiment, the method further includes calibrating the tamp including conducting a tamp operation on a single puck of ideal puck height, checking the tamp position and making calibration adjustments, if needed.

In another aspect, there is provided a system for implementing the above described method, including: a controller; a tamper module to conduct a tamping operation and provide tamp position information to the controller; and a user interface module to facilitate user operation of the system, the interface module providing the user with operational prompts and allowing for the user to operate the grinder and conduct a tamping operation.

In one embodiment, the system further includes a motor status sensor, which provides information on either the current or the motor speed of the grinder, to indicate the presence of beans in the hopper and/or blockages.

In one embodiment, the system further includes a grinder module which receives start and stop signals from the controller and provides feedback to the controller when the grind is complete.

In another aspect, the invention provides a system including: a controller; a grinder module which receives start and stop signals from the controller and provides feedback to the controller when the grind is complete; a tamper module to conduct a tamping operation and provide tamp position information to the controller; and a user interface module to facilitate user operation of the system, the interface module providing the user with operational prompts and allowing for the user to operate the grinder and conduct a tamping operation, wherein the system is configured to monitor tamp depth.

In one embodiment, the system further a motor status sensor, which provides information on either a current or a motor speed of a coffee grinder, to indicate the presence of beans in the hopper and/or blockages.

In one embodiment, the system is configured to determine if the tamp depth is within a predetermined tolerance and adjust a grind time if the tamp depth is outside the pre-determined tolerance.

In one embodiment, the system determines deviation of the tamp depth, and if outside the pre-determined tolerance, provides information to a user through a user interface of tamp depth deviation, together with deviation polarity.

In one embodiment, the system further provides user prompts through the user interface to adjust grind time manually.

In one embodiment, the system is adapted to monitor a status of a hopper, grinder motor and portafilter and to turn off the grinder off if the hopper is empty, the grinder is blocked or the portafilter is not present.

In one embodiment, the system is adapted to record the actual grind time if the grinder motor is turned off and updating the grind time for a subsequent grind to include a time required to complete a grinding operation when the grinder is again turned on.

In one embodiment, the controller is arranged to notify a user of the hopper, grinder motor and portafilter status through a user interface and notifying the user of the updated grind time.

In one embodiment, the controller determines if an incorrect basket size has been selected by the user by measuring the tamp depth to assess if the tamp depth is in a range that correlates with an expected tamp depth for the selected basket size.

In one embodiment, the controller notifies a user through the user interface if the determination is an incorrect basket size has been entered by the user and updating the grind time to reflect a correct basket size selection.

In one embodiment, the system is adapted to calibrate a coffee machine using pucks of known heights set to the pre-determined tolerances, conducting a tamping operation and checking if the tamp position correlates to the known puck heights and making any calibration adjustments, if needed.

In one embodiment, the system is adapted to calibrate the tamp by conducting a tamp operation on a single puck of ideal puck height, checking the tamp position and making calibration adjustments, if needed.

### BRIEF DESCRIPTION OF THE DRAWINGS

The invention is more fully described, by way of non-limiting example only, with reference to the following drawings, in which:

FIG. 1 is a perspective view of a machine;

FIG. 2 is another perspective view of the machine;

FIG. 3 is a partial sectional view of the machine showing a tamping mechanism in an upper position;

FIG. 4 is a similar view to FIG. 3, showing the mechanism in a lower position;

FIG. 5 is a similar view, illustrating the lever in a lowered position;

FIG. 6 is a perspective cross-sectional view showing the tamping mechanism;

FIG. 7 is a side cross-sectional view the machine with the mechanism in a raised position;

FIG. 8 is a side cross-sectional view showing the mechanism in a middle position;

FIG. 9 is a side cross-sectional view showing the mechanism in a tamping position;

FIG. 10 is a side cross-sectional view showing a portafilter fitted to the machine in an under-dose condition;

FIG. 11 illustrates an ideal height position of the tamp for an ideal dose condition;

FIG. 12 is a cross-sectional view showing the position of the tamp for an over-dose condition;

FIG. 13 is an enlarged view of a top section of the machine showing a return device;

FIG. 14 is a similar view to FIG. 13, illustrating the return device in an extended condition;

FIG. 15 illustrates the lever in a lifted position and the condition of the tamping force control assembly;

FIG. 16 is a similar view to FIG. 15, with the lever in a home position;

FIG. 17 is a perspective view of another example of a tamping mechanism with a lever in a home position;

FIG. 18 is a similar view showing the lever in a lower position;

FIG. 19 is a cross sectional view of the mechanism of FIGS. 17 and 18 in a raised position;

FIG. 20 is a view similar to FIG. 19 showing the mechanism in an intermediate position;

FIG. 21 is a view similar to FIG. 20 showing the mechanism in a tamping position;

FIG. 22 is a diagrammatic side perspective view of another example of a tamping mechanism;

FIG. 23 is a similar view of the mechanism from another side;

FIG. 24 illustrates the mechanism in a lower position;

FIG. 25 shows the mechanism in an upper position;

FIG. 26 is a partial cross-sectional view of the mechanism of FIG. 25;

FIG. 27 is a partial cross-sectional view of the mechanism from an opposite side;

FIG. 28 is a cross-sectional view of the mechanism when the lever is in a home position;

FIG. 29 is a cross-sectional view of the mechanism in a lower position;

FIG. 30 is a cross-sectional view of the mechanism in an intermediate position;

FIG. 31 is a top perspective view of part of the tamping mechanism;

FIG. 32 is a top perspective view of the mechanism from another side;

FIG. 33 illustrates a switch activated by the shaft;

FIG. 34 is a top perspective view showing a return device;

FIG. 35 is a perspective view showing the location of a VR sensor;

FIG. 36 illustrates a gear associated with the lever;

FIG. 37 illustrates a matching gear for driving the mechanism;

FIG. 38 is a cross-sectional view of an example of another tamping mechanism in a lowered position;

FIG. 39 if a view similar to that of FIG. 38, illustrating the mechanism in an intermediate position;

FIG. 40 is a cross sectional view showing the mechanism in a raised position;

FIG. 41 is a perspective view showing the mechanism in a lowered position;

FIG. 42 is a perspective view of the mechanism in a raised position;

FIG. 43 is a perspective view of part of a tamping unit showing another example of a tamping mechanism;

FIGS. 43a to 43d show possible locations of sensors in the tamping unit;

FIG. 44 is cross-sectional view showing the mechanism is a raised position;

FIG. 45 is a similar view to FIG. 45 showing the mechanism in an intermediate position;

FIG. 46 is a similar view to FIG. 45 showing the mechanism in a tamping position;

FIG. 47 is an exploded view of a clutch;

FIG. 48 is another exploded view of the clutch;

FIG. 49 is a perspective view of an example of a tamp;

FIG. 50 is a cross-sectional view of the tamp;

FIG. 51 is an exploded view of the tamp from an underside;

FIG. 52 is an exploded view of the tamp from an upper side;

FIG. 53 is an exploded view of another example of the tamp;

FIG. 54 is an exploded view of the tamp of FIG. 53 from an upper side;

FIG. 55 is a cross-sectional view of another example of a tamp;

FIG. 56 is an enlarged cross-sectional view of a section of the tamp of FIG. 55;

FIG. 57 is a cross-sectional view of another example of a tamping unit;

FIG. 58 is a cross-sectional view of the tamping unit showing a tamp in a rest position;

FIG. 59 is a similar view of the tamping unit, with a tamping mechanism removed for clarity;

FIG. 60 is a cross-sectional view of a part of the tamping unit;

FIG. 61 is a perspective view of the tamping unit with part of the tamping mechanism removed for to illustrate dual tracks;

FIG. 62 is an enlarged view of a sensor and damper used in the tamping unit;

FIG. 63 is an end view of a portafilter in a portafilter holder;

FIG. 64 is a cross-sectional view of the portafilter holder of FIG. 63;

FIG. 64A are perspective views of the portafilter holder;

FIG. 65 is an exploded view of the portafilter holder;

FIG. 66 is a bottom perspective view of the portafilter in the portafilter holder;

FIG. 67 is a diagrammatic representation of a system for operating the machine;

FIG. 68 illustrates a dosage algorithm;

FIG. 69A illustrates additional steps in the algorithm of FIG. 68;

FIG. 69B illustrates further steps in the algorithm of FIG. 68;

FIG. 70A illustrates coordinate frames at different joints in the algorithm of FIG. 68;

FIG. 70B illustrates a graph comparing current values when beans are and are not present over a period of time in the algorithm of FIG. 68;

FIG. 70C illustrates a graph comparing motor speed values when beans are and are not present over a period of time in the algorithm of FIG. 68;

FIG. 71 illustrates another dosage algorithm;

FIG. 72 is a front view of the machine;

FIG. 73 shows a section of the user interface of the machine, illustrating a correct dosage;

FIG. 74 illustrates the user interface displaying an overdose condition;

FIG. 75 illustrates the user interface showing an extreme overdose condition;

FIG. 76 illustrates the user interface displaying an underdose condition;

FIG. 77a is a perspective view of a cover over a tamp chute of the machine;

FIG. 77b is a perspective view of the cover removed from the machine;

FIG. 78 shows another example of a portafilter holder;

FIG. 79 shows a front view of the holder of FIG. 78;

FIG. 80 is a section view along the line A-A of FIG. 79;

FIG. 81 is a side view of the holder of FIG. 78;

FIG. 82 is a section view along the line B-B of FIG. 81;

FIG. 83 shows an exploded view of another example of a tamp;

FIG. 84 shows an exploded view of the tamp of FIG. 83;

FIG. 85 is a side view of the tamp of FIG. 83;

FIG. 86 is a section view along the line A-A of FIG. 85;

FIG. 87 is a side view of the tamp of FIG. 83;

FIG. 88 is a section view along the line A-A of FIG. 87;

FIG. 89A is an exploded view of another example of a tamp;

FIG. 89B is an exploded view of the tamp of FIG. 89A; and

FIG. 90 is a section view of the machine of FIG. 1 including the tamp of FIGS. 83 to 89.

### DETAILED DESCRIPTION

### Examples of Tamping Mechanisms

Examples of tamping mechanisms will be described in the following, where like reference numerals will be used to denote like parts.

### Example 1

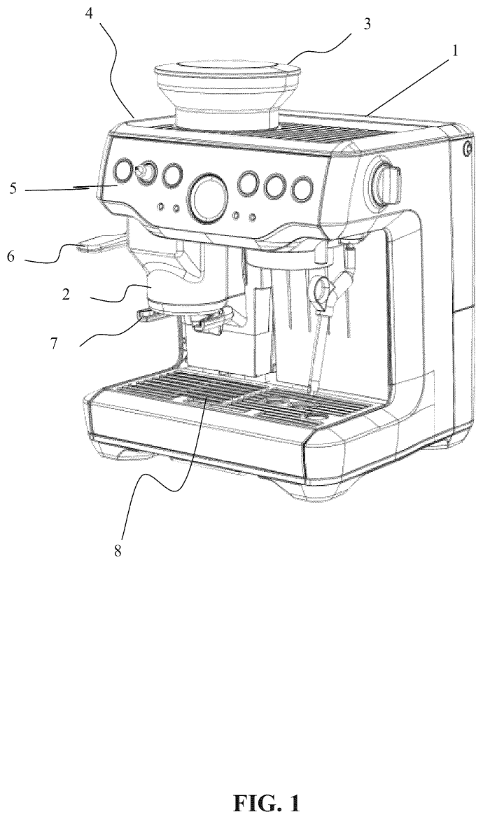

FIG. 1 shows an embodiment of a machine 1 with a tamping unit 2, a coffee bean hopper 3, a casing 4, a user interface panel 5, a lever 6 and a portafilter holder 7 positioned above a drip tray 8.

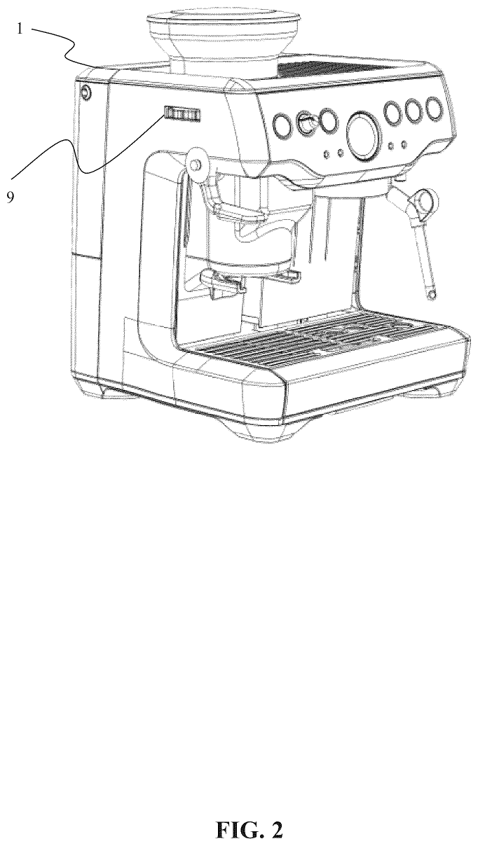

FIG. 2 shows the machine 1 as having an adjustment dial 9 for setting grind size.

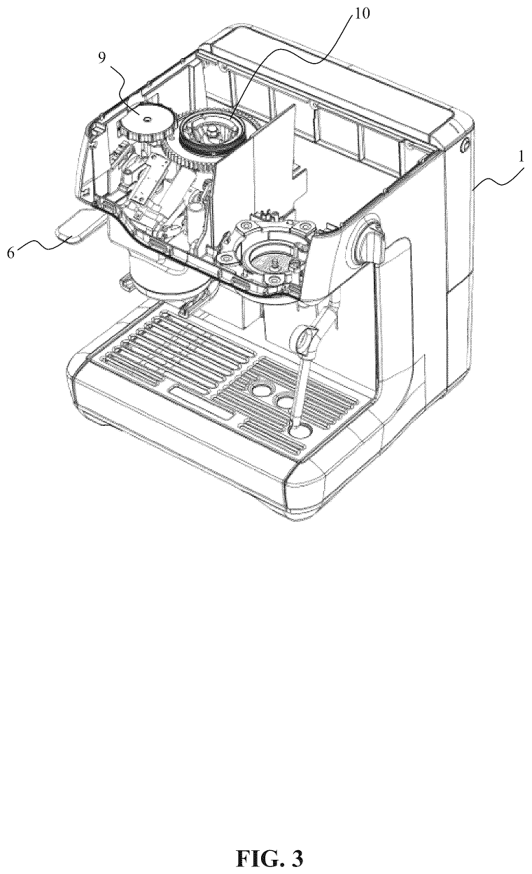

FIG. 3 is a partial sectional view of the machine 1. A coffee grinder 10 is shown interfacing with the adjustment dial 9 for grinding coffee beans delivered from the hopper 3 of FIG. 1 into coffee grounds. The lever 6 is shown in a home position which corresponds to a tamping mechanism 11 being in a raised position.

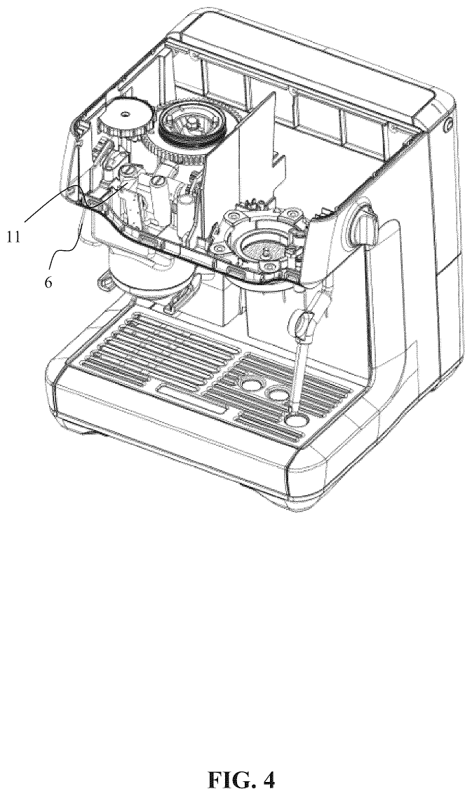

In FIG. 4, the lever 6 has been moved to a lowered position, which corresponds to the mechanism 11 being in a tamping position.

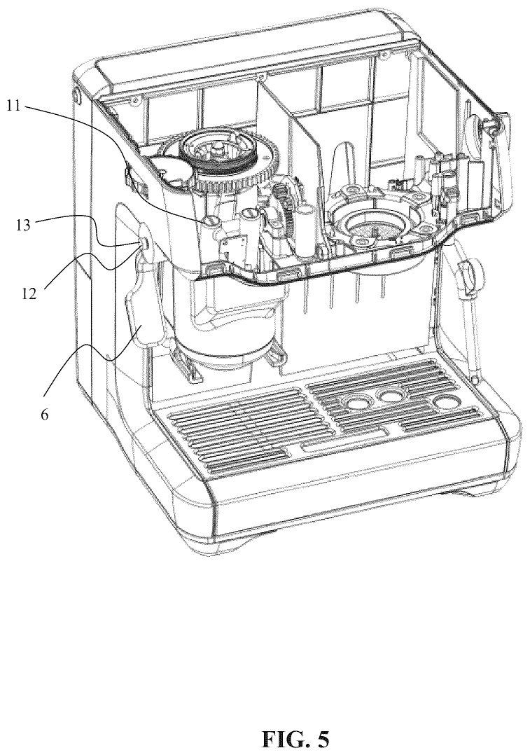

FIG. 5 also shows the lever 6 lowered. The lever 6 is connected to a shaft 12 which acts as an actuator 13 to drive the mechanism 11 between the raised and tamping positions along a stroke length.

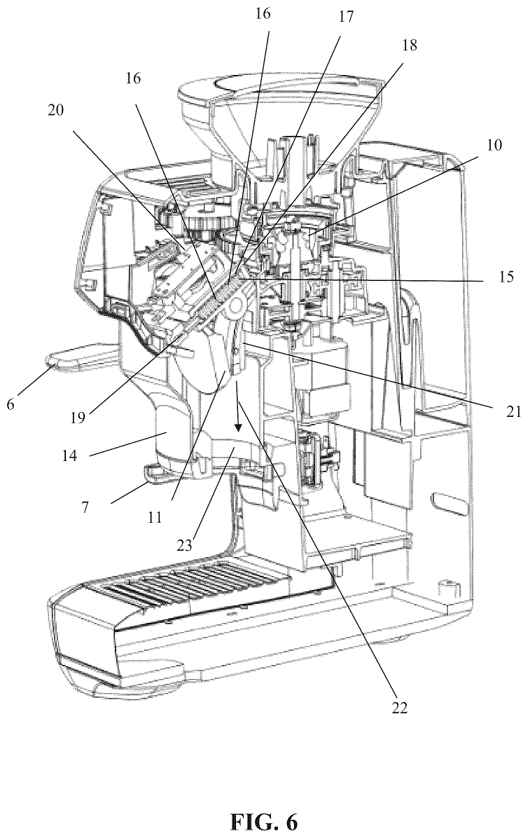

FIG. 6 is a partial cross-sectional view where the lever 6 has been returned to the home position and the mechanism 11 is in the raised position. The mechanism 11 is coupled to a tamp 14 which is held in a raised rest position.

The mechanism 11 carries a tamping force control assembly 15, which is formed of a housing 16 which houses a biasing element 17 in the form of a compression spring 18. In some implementations, the biasing element 17 may be in the form of other types of springs, such as a tension spring. It is preferable to have the biasing element 17 pre-loaded/pre-tensioned (i.e. the biasing element is not in its natural position when installed) so that: the tamping force can be more precisely controlled; the stroke length of the tamping mechanism is decreased, which allows the height/size of the machine to be reduced to provide a more compact machine; the required rotation of the lever 6 by the user is reduced; and less force is required by the user to tamp the coffee grounds. It is preferrable to have one or more biasing elements 17 acting on the linkage 7 so that the tamping force applied to the ground coffee is controlled.

More particularly, the pre-tensioned or pre-loaded biasing element 17 provides the following benefits as compared with a non-pretensioned (non-preloaded) biasing element 17: a lower biasing rate (a lower spring rate in the current embodiment) so as to give a more consistent and accurate tamping force over the stroke length; and a reduced compression distance for the coffee grounds over the stroke length of the mechanism 11 to achieve predetermined tamping force, which allows reduced rotation of the lever 6 by the user and reduced force required by the user to rotate the lever 6 to tamp the coffee grounds which, as mentioned above, can reduce the height and size of the machine 1 to provide a more compact design

A sensor 20 is provided which includes a connecting rod 19 and the relative position of the connecting rod 19 may be used to monitor the distance travelled by the tamping mechanism 11. When the coffee puck is tamped/pressed, the biasing element 17 is compressed, which results in movements in the connecting rod 19. It should be noted that the sensor 20 with a connecting rod 19 is merely an example of means for measuring distance travelled by the tamping mechanism 11.

A grind chute 21 extends from the grinder 10 which, when activated, delivers ground coffee along a flow path 22 and out through a tamp chute 23, to a location centrally of the portafilter holder 7, directly beneath the tamp chute 23. The tamp mechanism 11 also travels within the tamp chute 23 between raised and tamp positions.

The rest position of the tamp 14, when the mechanism 11 is raised, is out of the flow path 22 of the ground coffee so as not to obstruct the delivery of coffee through the tamp chute 23.

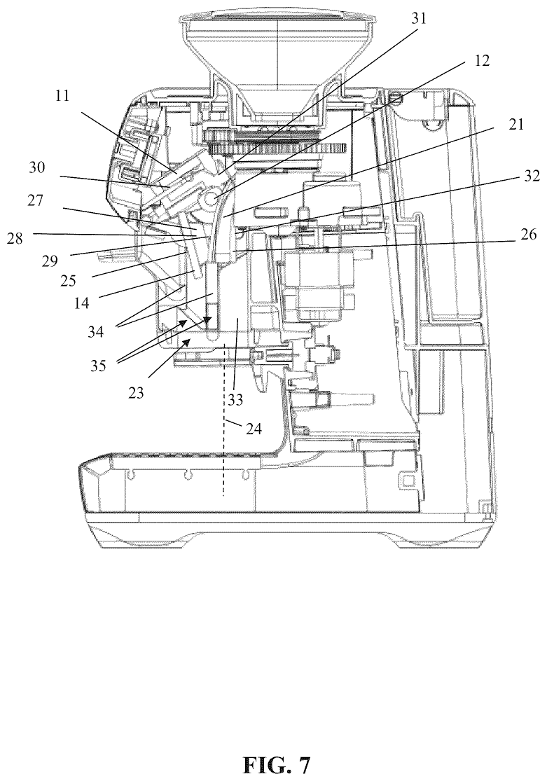

FIG. 7 more clearly illustrates the relative positioning of the tamp 14 and the grind chute 21.

The grind chute 21 is positioned directly above and within a top region of the tamp chute 23 in substantial alignment with a centreline 24 of the tamp chute 23. The mechanism 11 is in a raised position such that a face 25 of the tamp 14 and mechanism 11 is rotated clear of a lower end 26 of the chute 21.

The mechanism 11 includes a linkage 30 connected to the shaft 12 at one end 31, for fixed rotation with the shaft 12. The tamp 14 includes a base 27, a body 28 and a coupler 29 to connect the tamp 14 to the linkage 30 by a rotary coupling 32 which allows the tamp 14 to rotate when moved out of and returned to the rest position.

The tamping unit 2 has an internal housing 33 extending upward from the tamp chute 23. The housing 33 assists in containing coffee grounds as they travel toward the tamp chute 23.

The housing 33 has guide structure 34 in the form of slots 35 that guide the tamper 14 as it is rotated and moved out of and returned to the rest position by the linkage 30.

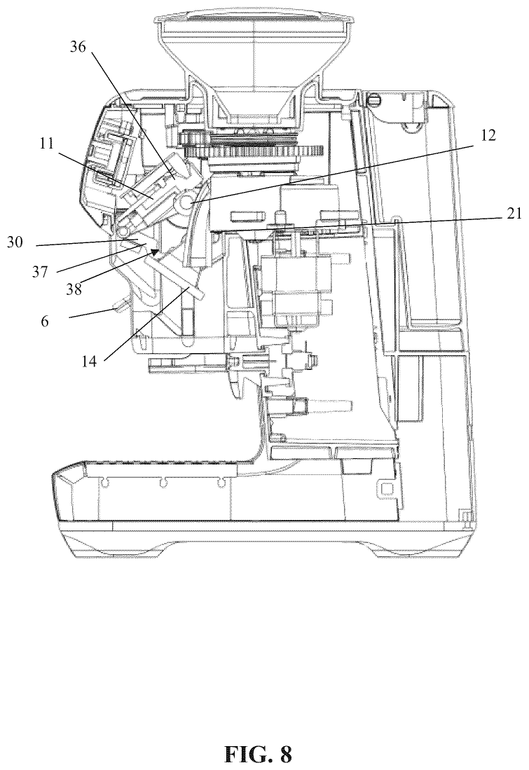

FIG. 8 illustrates the lever 6 in a partially lowered condition, which has caused rotation of the mechanism 11 to a middle position. The linkage 30 of the mechanism 11 is articulated with a first member 36 fixed to rotate with the shaft 12 when the lever 6 is pressed down. The first member 36 is hinged to a second member 37 which is pivoted away from the first member 36. The second member 37 is connected to the tamp 14 such that downward movement of the second member 37 causes the tamp 14 to be lowered along the guide structure 34 and rotated under the grind chute 21.

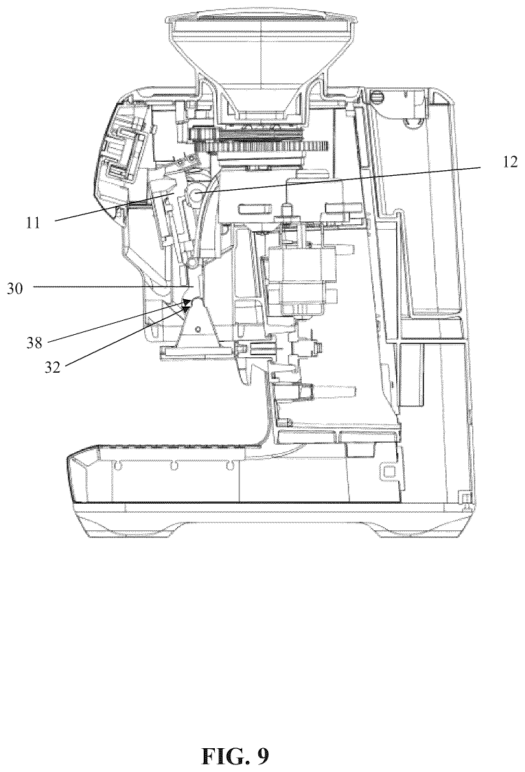

FIG. 9 shows the second member 37 also includes a notch 38 to accommodate the coupling 32 when the mechanism 11 is in the tamping position and the linkage 30 is fully extended. In that position, rotational force from the shaft 12 is translated into axial loading on the tamp 14 through the coupling 32.

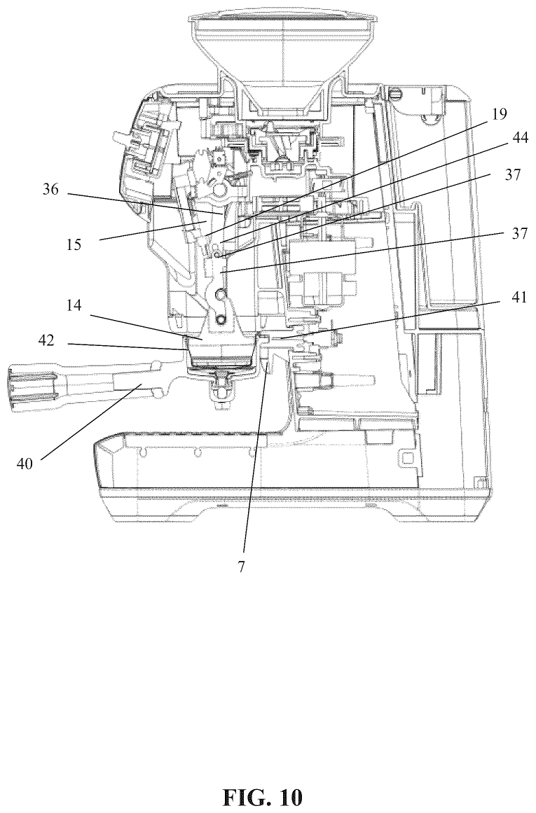

FIG. 10 shows a portafilter 40 fitted into the portafilter holder 7. A switch 41 is used to detect the presence of the portafilter 40 which previously enabled the grinder to be activated and resulted in coffee grounds (not shown) being delivered into a basket 42 carried by the portafilter 40.

The mechanism 11 is in the tamping position, where the tamp 14 has been lowered through the tamp chute 23 of the tamping unit 2 to sit inside the basket 42 for tamping the coffee grounds into a puck (also not shown for clarity).

FIG. 10 represents an under-dose condition in which a less than ideal amount of coffee grounds has been delivered to the portafilter 40 for tamping. An ‘ideal’ amount of coffee can be determined based on many parameters e.g. coffee bean characteristics, grinder settings, brew settings, filter basket geometry parameters, etc. It may also selected by the user as they see fit. In any case, in an under-dose condition, the tamp 14 has been forced to a position lower than ideal and the second member 37 of the linkage 30 is urged toward a lower end 43 of a limited movement connection 44 with the first member 36 under action of the tamping force control assembly 15. Although an under-dose condition is described, in an underdose, overdose or ideal condition as well: the second member 37 is urged toward an end of a limited movement connection 44 with the first member 36 under action of the tamping force control assembly 15 where the reaction force of the tamp 14 on the coffee grounds pushes the second member 37 against the bias of the tamping force control assembly 15 while the connecting rod 19 is driven back into housing 16. The difference between different states is the location of the end relative to the limited movement connection 44.

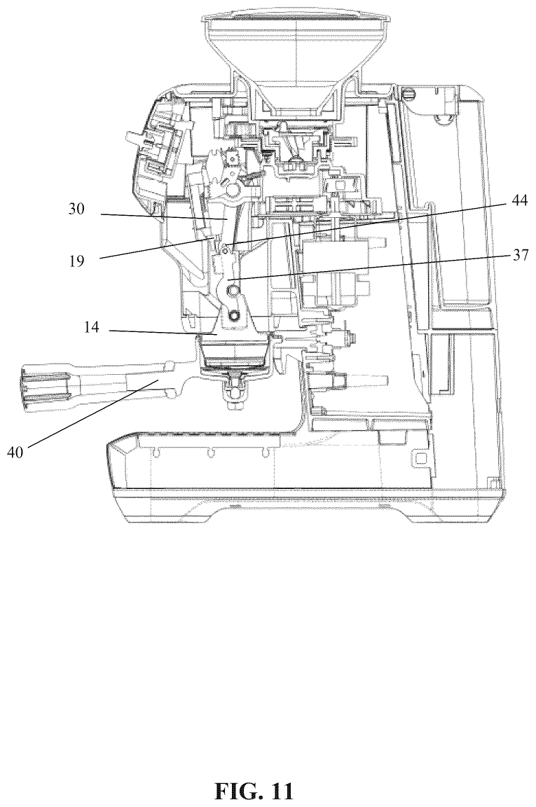

FIG. 11 shows the height of the tamp 14 when an ideal dose of coffee has been delivered into the portafilter 40. At that height, the reaction force of the tamp 14 on the coffee grounds pushes the second member 37 against the bias of the tamping force control assembly 15 to drive the second member 37 higher in the limited movement connection 44 such that the second member 37 pushes against the connecting rod 19.

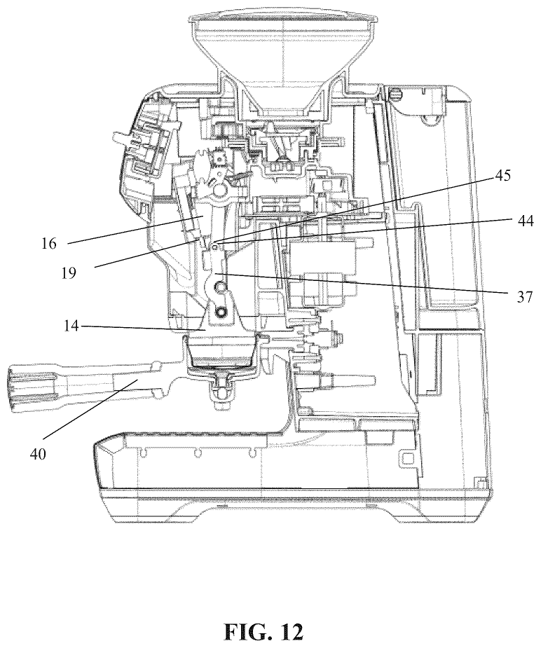

FIG. 12 illustrates an over-dose condition, in which a more than ideal amount of coffee grounds has been delivered to the portafilter 40. In this condition, the tamp 14 is positioned even higher and the reaction force on the tamp 14 causes the second member 37 to be urged toward an upper end 45 of the limited movement connection 44 and the connecting rod 19 to be driven back into the housing 16.

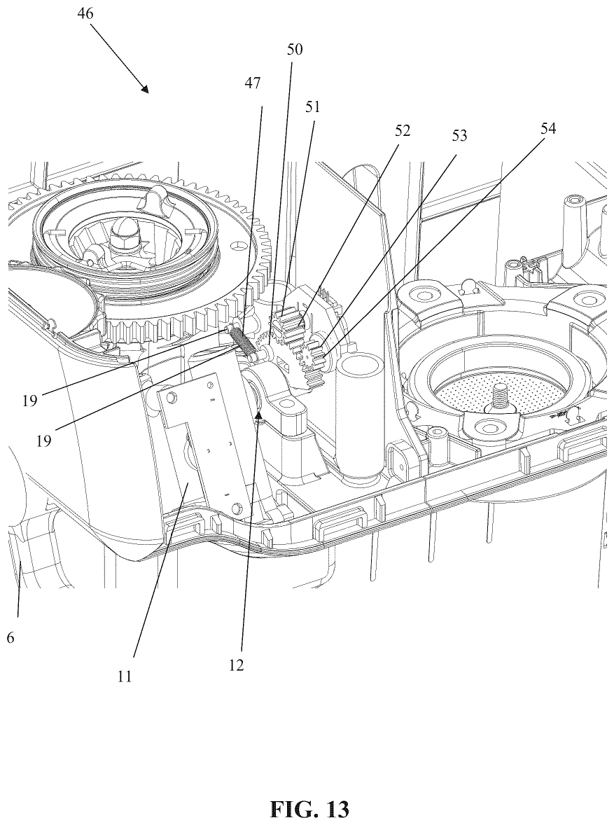

Referring now to FIG. 13, a cut-away section 46 of the machine 1 is shown. The lever 6 is shown in a home position and the mechanism 11 is in a corresponding raised position. A return device 47 is also shown which biases the shaft 12 and lever 6 into the home position. The return device 47 is illustrated as a tension spring 48 which acts between a fixed mount 49 and a control gear 50 connected to the shaft 12.

A rotary position sensor 51 is also provided which receives input from a cog 52 that engages the gear 50 and allows the position of the lever 6 to be monitored by way of the relative rotational position of the shaft 12, which also provides an indication of the corresponding position of mechanism 11. The rotary sensor 51 may also be placed in alternative locations and may, for example, be used to instead monitor rotation of the gear 50; the shaft 12; damper 53; or the lever 6

A damper 53 is also shown, which provides rotational resistance through a cog 54 which also engages with the gear 50.

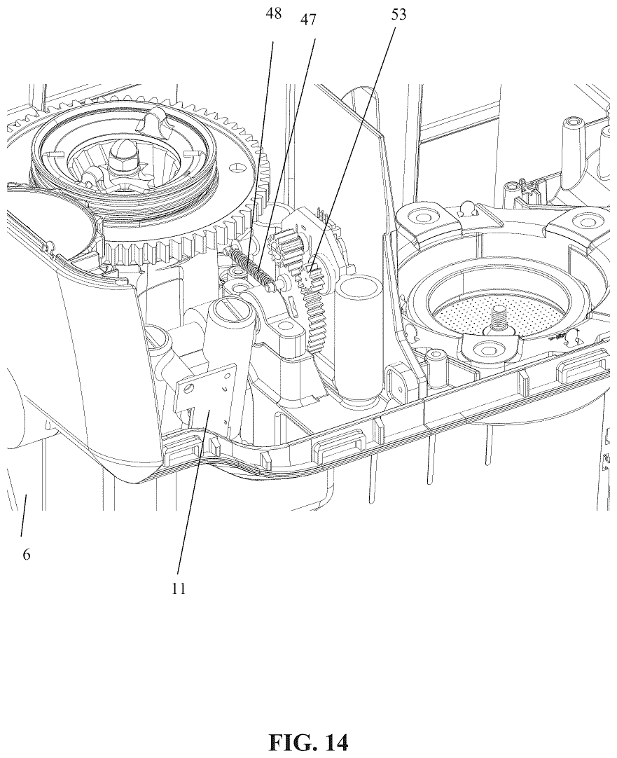

FIG. 14 illustrates the lever 6 in a lowered position, where the mechanism 11 is in a corresponding tamping position. The spring 48 is shown in an extended state whereby the return device 47 biases the lever 6 back toward the home position under spring force. The damper 53 is configured to balance the spring force while the lever 6 is lowered and the mechanism 11 is in the tamping position as well as soften the return of the mechanism 11.

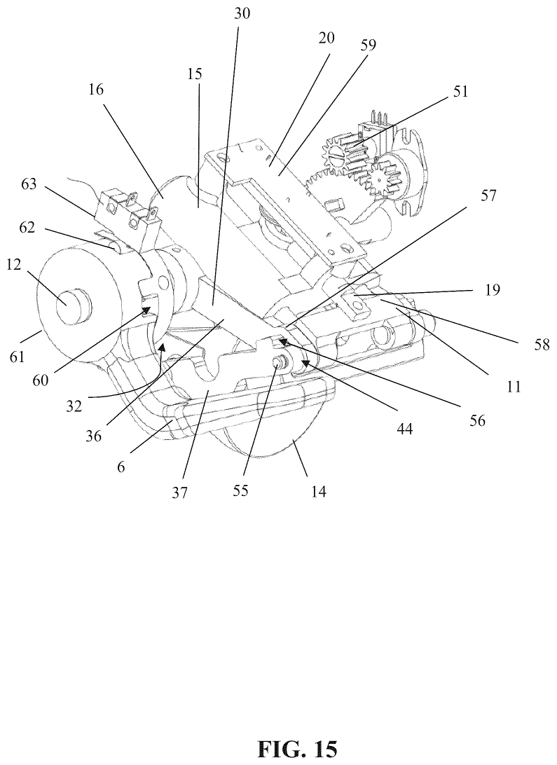

FIG. 15 provides a clearer illustration of the tamping force control assembly 15 and sensor 20. The mechanism 11 is again shown in the raised position, with the tamp 14 supported in an elevated rest position by the second member 37 via the coupling 32. The second member 37 is attached for hinged movement relative to the first member 36 by the limited movement connection 44 which is formed by a pivot 55 being slidable received in a slot 56 formed at the end 57 of the first member 36. The sensor assembly 20 is fixed onto the first member 36 and is connected to the second member 37 via a connecting assembly 58 in the form of a crosspiece. The connecting rod 19 passes through the sensor 20 which is integrated into a PCB 59 such that the relative position of the connecting rod 19 and thereby the tamp 14 can be determined.

The sensor 20 is preferably a linear position/displacement sensor, also known as a VR sensor, although any other suitable form of linear position sensor may be used. Feedback from the sensor allows the height of the tamp 14 to be ascertained when the mechanism 11 is extended to the tamping position, at the end of the downward stroke, and this in turn reveals the tamp depth (i.e. height of the coffee puck). The rotary position sensor 51 may also be used to provide information on the linear extension of the mechanism 11 as the measured rotational position of the shaft 12 is directly related to the degree of extension of the mechanism 11. The user can be provided with this information to understand where the tamp 14 is located during and/or after tamping. The tamp depth will vary depending on the dosage of coffee grounds which needs to be tamped. In an overdosed condition, the extension of the mechanism 11 will be reduced when the linkage 30 is fully extended, leading to a reduced tamp depth (i.e. increased puck height) while in an underdosed condition, the mechanism 11 will be further extended, resulting in a greater tamp depth (i.e. reduced puck height). More particularly, in an overdose condition, when the tamp travel distance is reduced the extension of the mechanism 11 is reduced, as such the compression of the biasing element 7 is also reduced, as detected by the sensor assembly 20 (via the connecting rod 19).

FIG. 15 also shows the lever 6 in a lifted position. The lever 6 is connected to the shaft 12 by a dog clutch 60 which allows free rotational movement of the lever 6 from the home position to the lifted position. This means the shaft 12 remains in a neutral position while a hub 61 of the lever 6 rotates counter clockwise, as viewed, until a protrusion 62 engages a grinder activation switch 63 which is used to activate the grinder 10 shown in FIG. 14

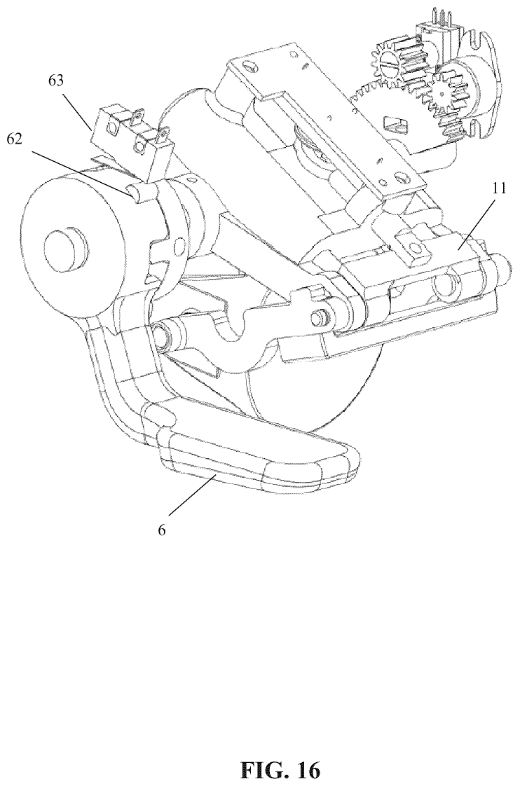

Following activation of the grinder 10, the lever 6 can be rotated back or biased toward the home position to move the protrusion 62 out of engagement with the switch 63, as shown in FIG. 16, ready for the lever 6 to be pressed down in order to lower the mechanism 11 into the tamping position.

### Example 2

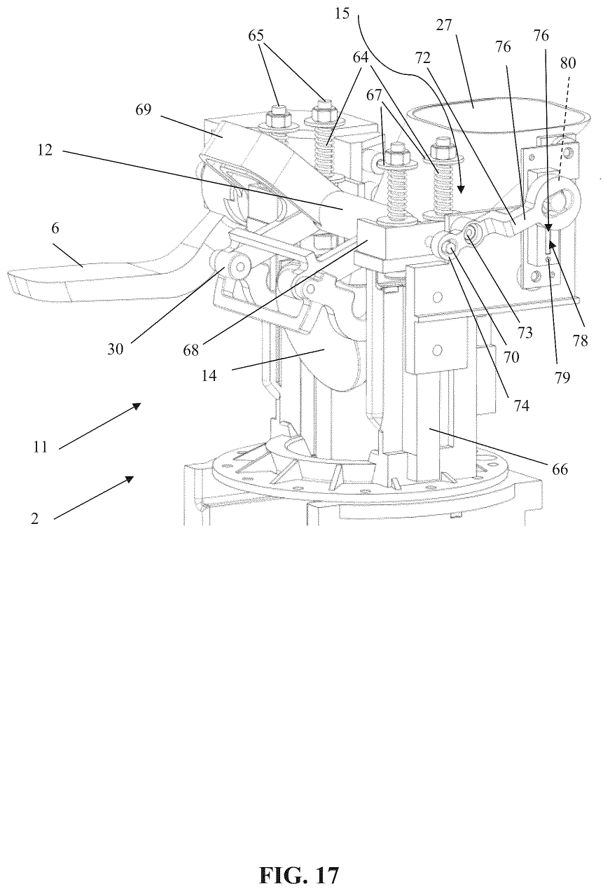

FIG. 17 shows another tamping unit 2 with tamping mechanism 11 and tamping force control assembly 15 similar to that described with reference to FIGS. 1 to 16.

The mechanism 11 includes an articulated linkage 30 connected to a shaft 12, with a lever 6 in a home position and the mechanism 11 in a raised position holding a tamp 14 clear of grind chute 21. The tamping control force assembly 15 includes compression springs 64 mounted on posts 65 attached to fixed structure 66 of the tamping unit 2. The springs 64 act between end washers 67 and a carriage 68 which supports the shaft 12.

The shaft 12 is coupled to the lever 6 by a U-shaped section 69 which allows rotational movement of the lever 6 to be transmitted to an end extension 70 of the shaft 12 while providing clearance for the springs 64 of the tamping force control assembly 15 positioned inside the U-shaped section 69.

The end extension 70 is coupled to a limited movement connector 71 which includes a rocker 72 that rotates about a pivot 73 connected to the fixed structure 66. One end 74 of the rocker 72 is rotatably mounted to the extension 70 and the other end 75 of the rocker 72 is provided with an elongate opening 76 that receives a follower 77. The follower 77 slides up and down a vertical channel 78 provided in a bracket 79 which is also fixed to the structure 66. The follower 77 is shown at an upper end 80 of the channel 78 when the lever 6 is in the home position.

FIG. 17 also shows the hub 61 connecting the lever 6 to the shaft 12 through a clutch 60, which allows free rotation of the lever 6 in an upward direction without rotating the shaft 12.

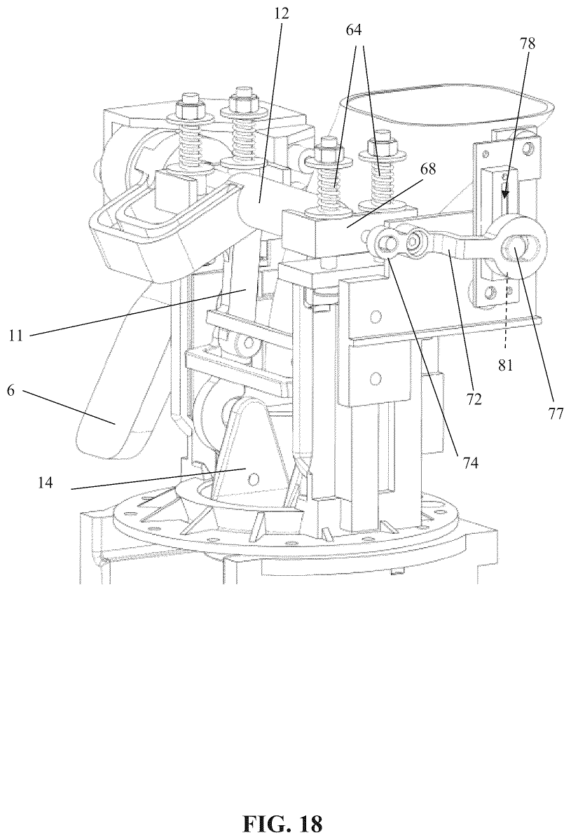

FIG. 18 shows the lever 6 in a lowered position, where the mechanism 11 has been lowered and tamping pressure has been applied. Reactive pressure on the tamp 14 as the lever 6 is pressed down is transmitted back through the mechanism 11 which causes the shaft 12 and carriage 68 to lift relative to the fixed structure 66, against the bias of the springs 64. The end 74 of the rocker 72 is lifted as a result, which rotates the rocker 72 and sends the follower 77 to a lower end 81 of the channel 78 to provide an end of travel stop to limit any further elevation of the carriage 68 such that a constant spring load of the tamping force control assembly 15 will be maintained for the tamping operation.

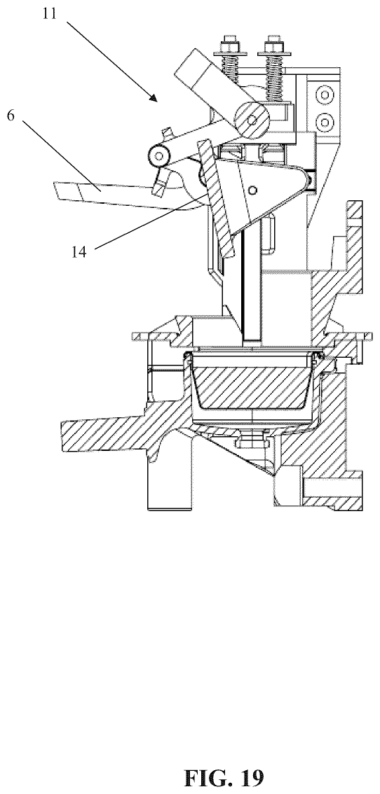

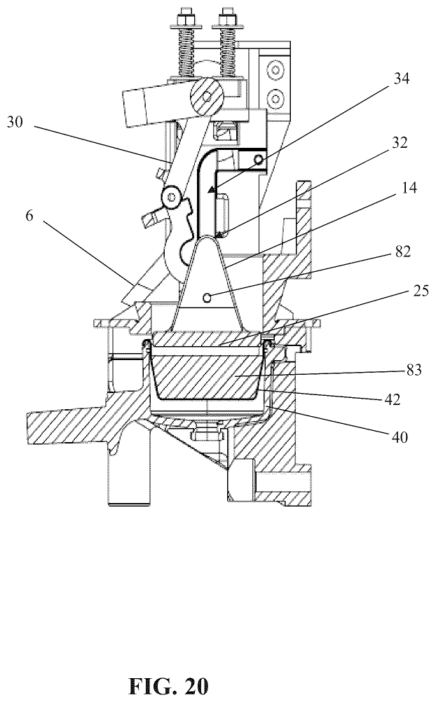

Referring now to FIG. 19, the lever 6 is shown in a home position where the mechanism 11 is raised and the tamp 14 is in a rest position. The lever 6 is pressed down in FIG. 20, which extends the linkage 30 of the mechanism 11 to an intermediate condition. In that condition, the tamp 14 has been moved from the rotated rest position along the guide structure 34 which guides the coupling 32 and a pivot 82 of the tamp 14 to orient the tamp face 25 to horizontal, at a location above a dose of coffee 83 in a basket 42 held by a portafilter 40.

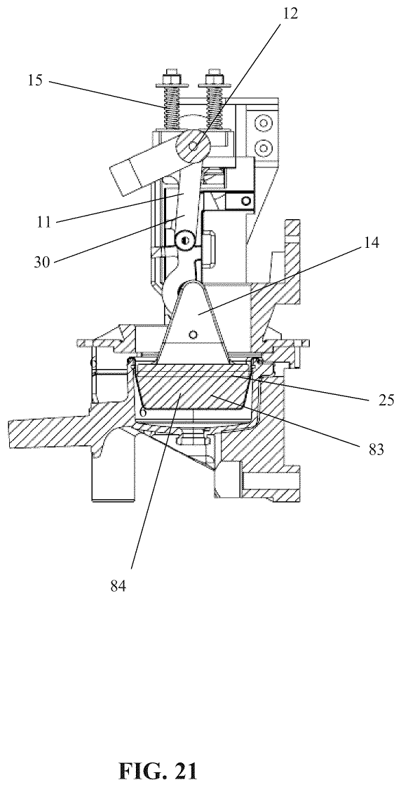

Further rotation of the lever 6 causes the mechanism 11 to move to the tamping position, where the linkage 30 is extended, as shown in FIG. 21, and the tamping force control assembly 15 forces the face 25 of the tamp 14 into the coffee 83, so as to form a puck 84. The relative rotation of the shaft 12 and the degree of compression of the tensioning assembly 15 can be used to determine the tamp depth. After tamping, the tamping mechanism 11 is returned to the rest position shown in FIG. 19, so that another dosing operation can be undertaken.

### Example 3

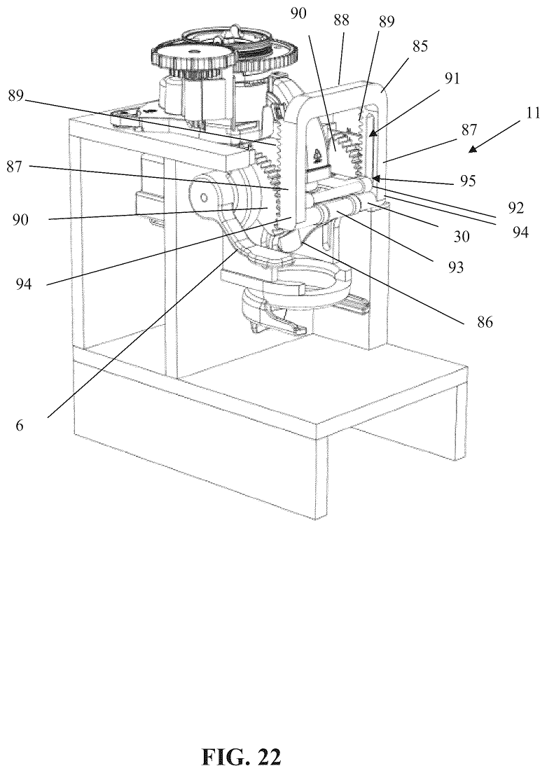

Referring now to FIG. 22, another example of a tamping mechanism 11 is shown and, again, like reference numerals will be used to denote like parts to those of the above described embodiments.

The mechanism of FIG. 22 includes a linkage 30 formed of a rack 85 with a fixed arm 86. The rack 85 is vertically oriented and includes upright legs 87 joined by a crossbeam 88. Each leg 87 has gear teeth 89 which mesh with a pinion 90 to drive the rack 85 up and down. A slot 91 is provided in each leg 87 to receive a roller 92. A beam 93 connects a base 94 of each leg 87 and supports a respective one of the arms 86 of the linkage 30 at a fixed angle.

A lever 6 is shown in the home position, where the linkage 30 is raised and the rollers 92 rest at a lower end 95 of the slots 91.

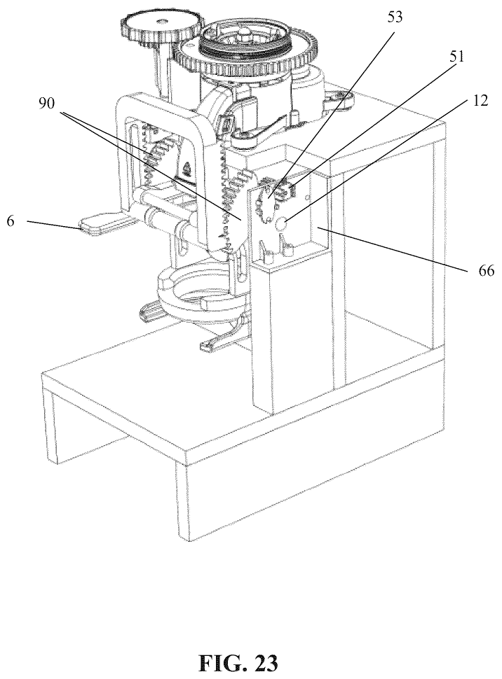

FIG. 23 shows a shaft 12 mounted in fixed structure 66, a rotary position sensor 51 and a damper 53. The pinions 90 are connected to the shaft 12 which is in turn attached to the lever 6.

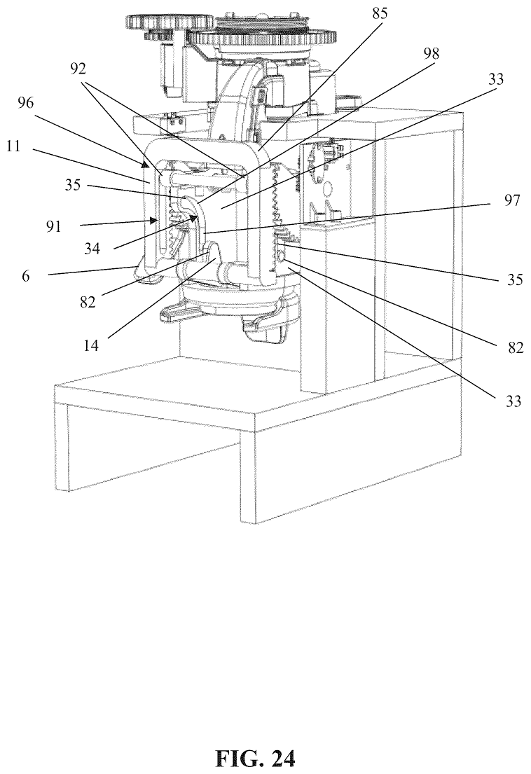

FIG. 24 illustrates the lever 6 in a lowered position, which correlates to the mechanism 11 being in a tamping position, where the rollers 92 are at the top 96 of the slot 91 of the rack 85. The tamp has a pivot 82 which projects in a sideward direction, into guide structure 34 in the form of a slot 35. The slot 35 is formed in a housing 33 and has a vertical part 97 and a curved top part 98. Additionally, or alternatively, the coupling 32 also projects in a sideward direction for guided engagement with the guide structure 34.

The tamp 14 has an identical pivot 82 on another side which is received in a matching slot 35 in the housing 33, at an opposite side of the tamp 14.

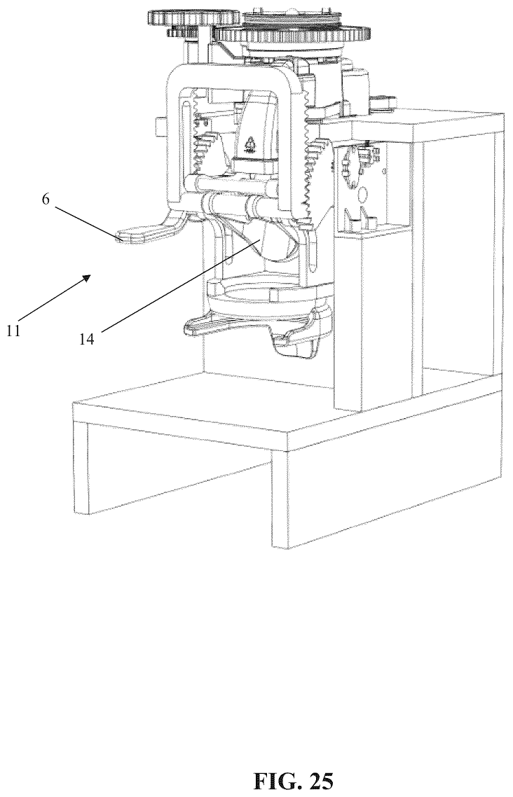

The pivots 82 track the path of the slots 33 and additionally or alternatively, the coupling 32 can also track the slots 33 when the mechanism 11 is raised and lowered such that the tamp 14 rotates back to a tilted orientation when the pivots 82 move through the curved top parts 98 of the slots 33, to a position shown in FIG. 25, when the mechanism 11 is raised and the lever 6 is returned to the rest position.

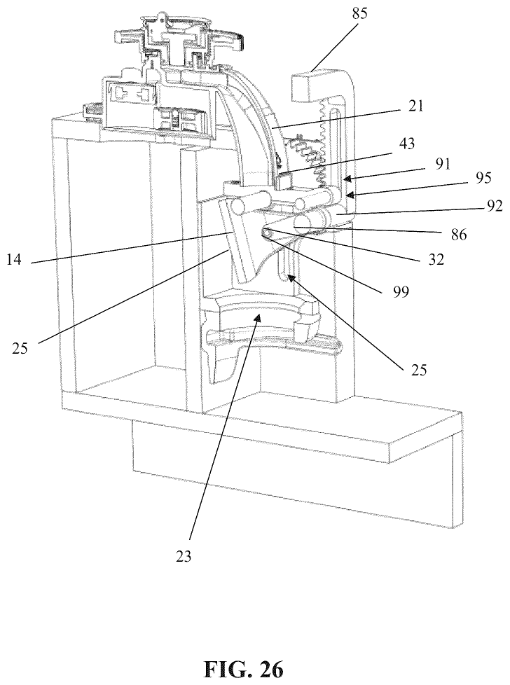

Referring to FIG. 26, when the tamp 14 is in the rest position, a face 25 of the tamp 14 and the mechanism 11 is rotated clear of a lower end 43 of the grind chute 21, which means coffee grounds can be delivered centrally through the tamp chute 23 for tamping, without obstruction by the tamp 14.

FIG. 26 also shows the roller 92 positioned at the lower end 95 of the slot 91 to prevent further raising of the rack 85.

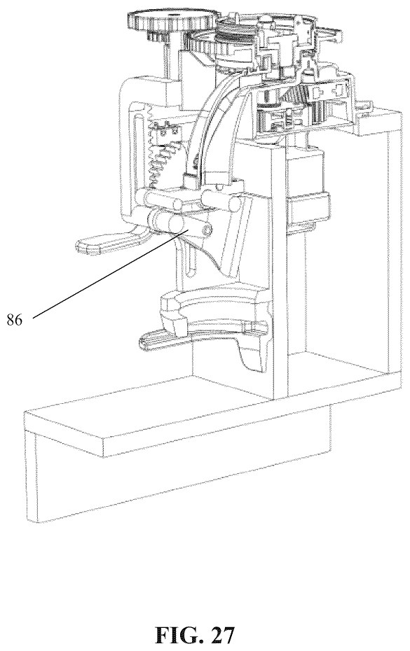

The rotary coupling 32 connects a remote end 99 of the arm 86 to a side of the tamp 14 so that the tamp 14 rotates about the arm 86 as the tamp 14 is raised along the guide slot 25, thereby tilting the face 25 of the tamp 14 away from the end 43 of the chute 21. The other arm 86 is connected in the same manner, as shown in FIG. 27.

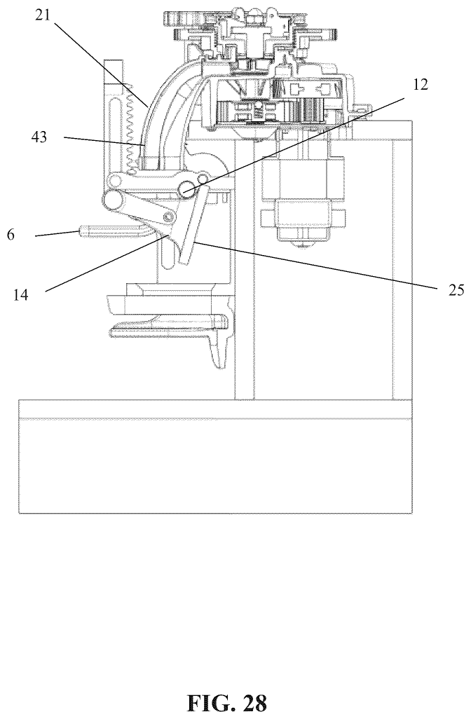

FIG. 28 more clearly shows the relative position of the face 25 of the tamp 14 and the grind chute 21. The tamp 14 is rotated up against the shaft 12 and clear of the end 43 of the chute 21 when the lever 6 is in the home position.

In FIG. 29, the mechanism 11 has been lowered and the tamp 14 extends out of the tamp chute 23, again in the tamping position, where the coupling 32 aligns with the vertical part 97 of the slot 25 so that the tamp 14 sits vertically and the face 25 of the tamp 14 is horizontal.

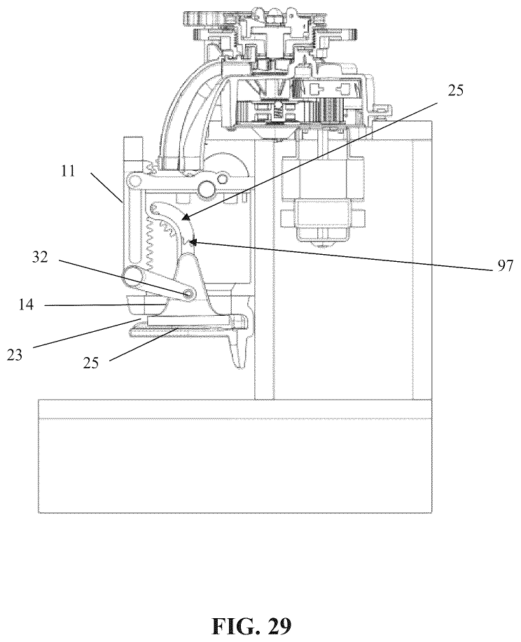

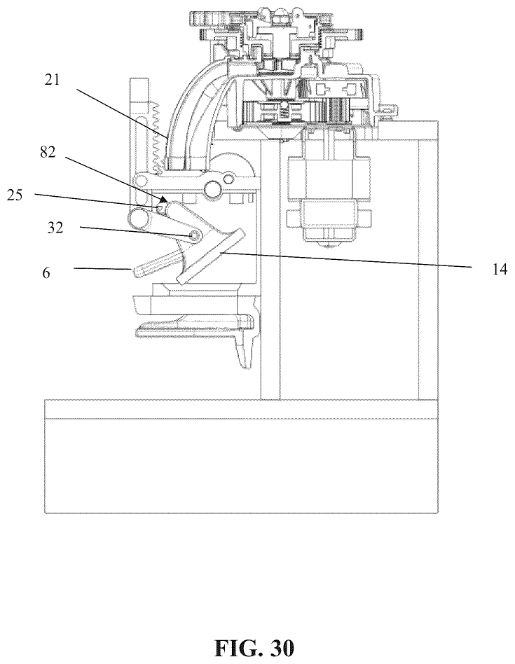

FIG. 30 illustrates the lever 6 and tamp 14 in an intermediate position, where the tamp 14 is partially rotated beneath the grind chute 21 about the coupling 32 and the pivot 82 which tracks the slot 25 between the rest and tamping positions.

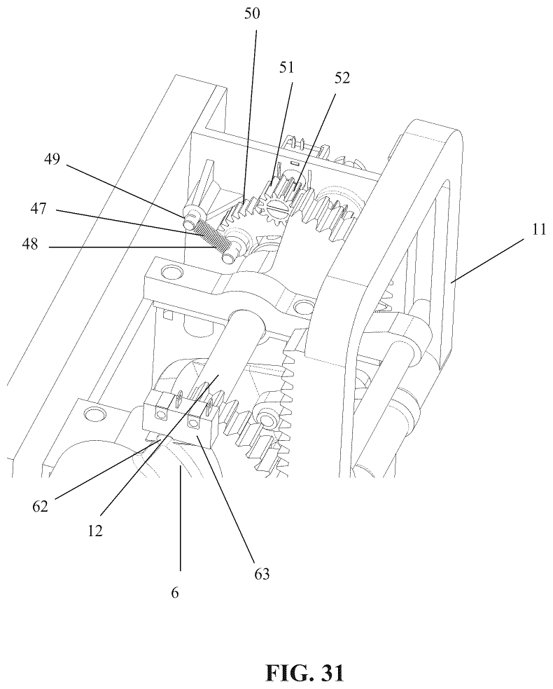

FIG. 31 shows a return device 47 in the form of a tension spring 48 connected between a fixed mount 49 and a control gear 50 which is fixed to rotate in unison with the shaft 12. A rotary position sensor 51 detects the rotary position of the shaft 12 through a cog 52 which engages the gear 50. The sensor 51 is preferably a potentiometer or POT sensor. The tamping mechanism 11 is in a raised condition and the output signal of the sensor 51 is used to monitor the tamp depth when the mechanism is lowered to the tamping position based on the relative rotation of the shaft 12. Again, the sensor 51 may be placed in alternative locations to, for example, monitor the rotation of the gear 50, the shaft 12. The damper 53 or the lever 6.

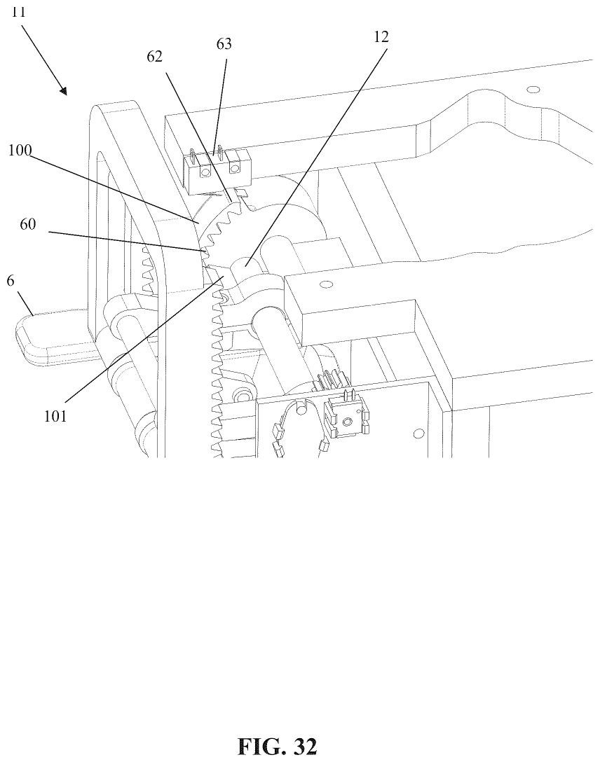

In FIG. 31, the lever 6 is raised so that a protrusion 62 engages a grinder activation switch 63, as more clearly shown in FIG. 32.

FIG. 32 also shows the protrusion 62 as integral to an annular gear section 100 fixed to the lever 6. The gear section 100 is disengaged from driving engagement with the shaft 12 when the lever 6 is raised from the home position which allows the lever 6 to be independently lifted to engage the grinder activation switch 63. In that a respect, the gear section acts as a clutch 60 between the lever 6 and the shaft 12.

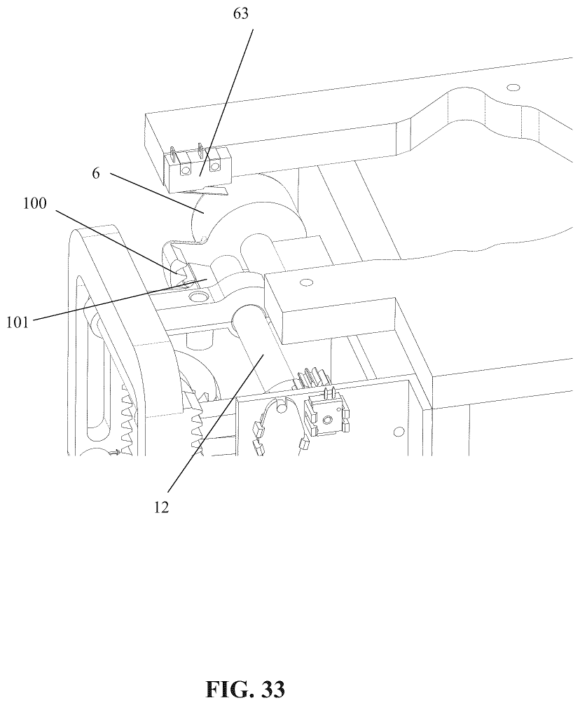

FIG. 33 shows the lever 6 in a lowered position, clear of the switch 63. The gear section 100 is re-engaged with the shaft 12 through the intermediate gear 101 which is keyed to the shaft 12 so that downward movement of the lever 6 after passing through the home position caused corresponding rotation of the shaft 12 and activation of the tamping mechanism.

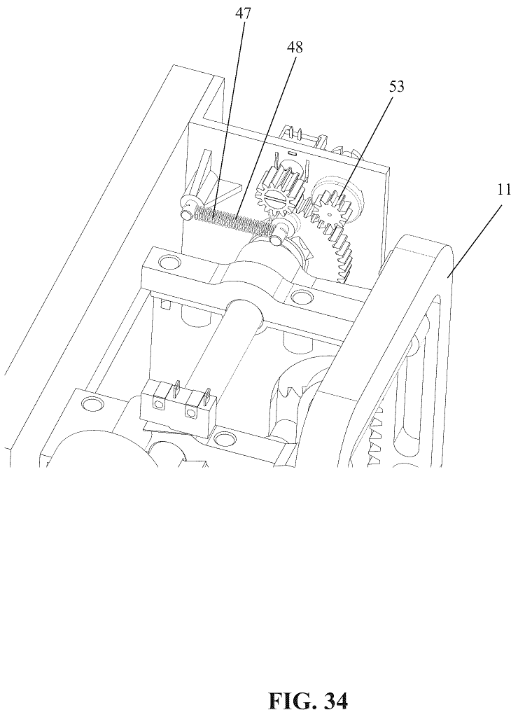

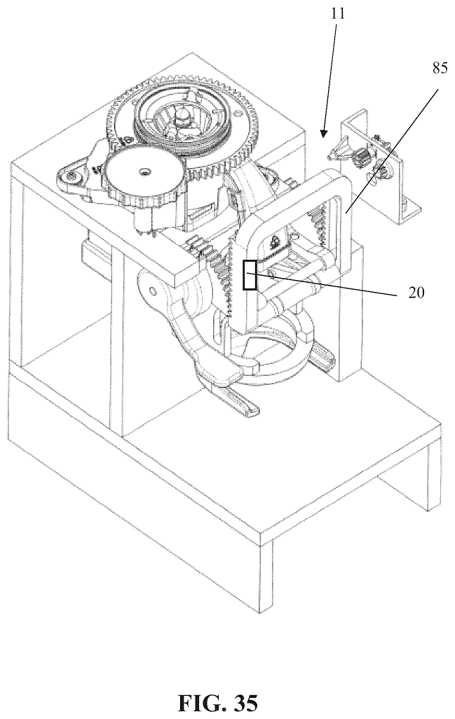

FIG. 34 shows the spring 48 in an extended state when the mechanism 11 is in the tamp position. In that state, the spring 48 of the return device 47 urges the mechanism 11 back to the raised position. A damper 53 is engaged at an end of the downward stroke of the mechanism 11 to resist the return device 47 and slow movement of the mechanism 11 near the tamping position. The principle purpose of the damper 53 is however to soften the return of the mechanism 11 from the tamping position to the raised position.

As mentioned above, the rotary sensor 51 may be used to monitor the extension of the mechanism 11 and the resulting tamping position, in order to determine the tamp depth. However, the tamping position and the tamp depth can instead be measured by a sensor 20 monitoring the vertical height of the rack 85, to provide a direct VR or linear distance reading.

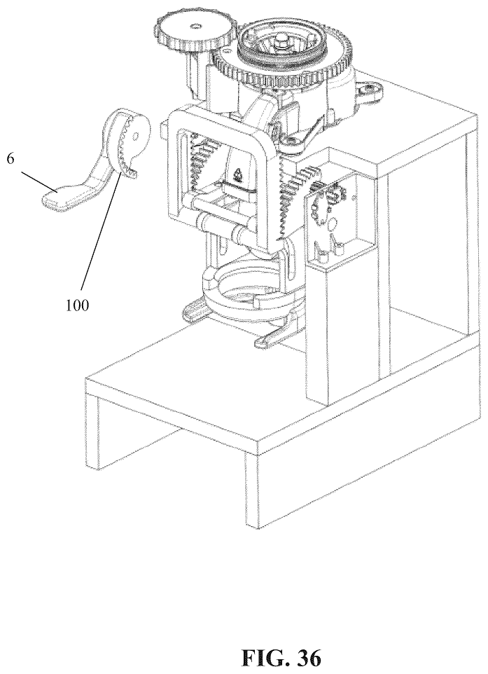

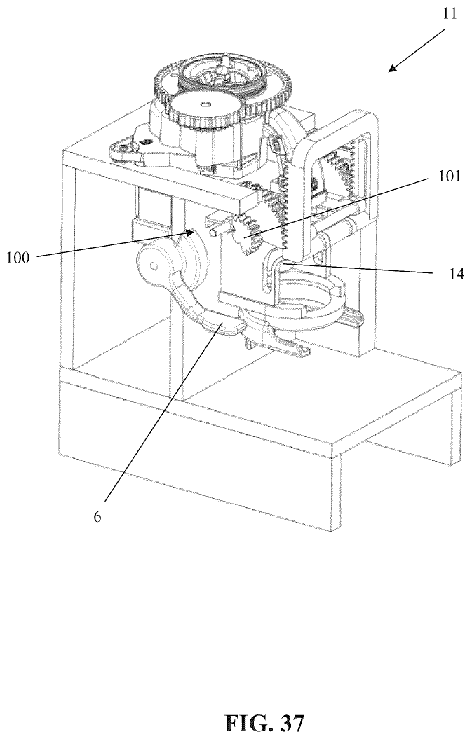

For completeness, FIG. 36 shows the gear section 100 attached to the lever 6 while FIG. 37 illustrates the intermediate gear 101 which is engaged by the gear 100, in order to drive the tamping mechanism 11 to move the tamp 14 between the rest and tamp positions. The arcuate length of the gear 100 is limited so that the lever is only able to drive the corresponding intermediate gear 101 when the lever 6 is moved between the rest and lowered positions. If the lever is moved upward from the home position, the gears 100 and 101 separate from driving engagement, which allows the lever 6 free rotational movement to initiate grinding, while leaving the mechanism 11 in the raised position during a grinding operation.

### Example 4

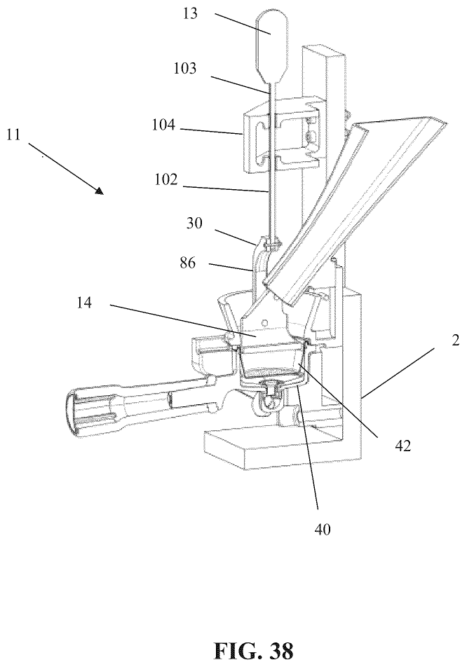

FIG. 38 illustrates another example of a tamping mechanism 11 of a tamping unit 2 and like parts to the above described examples will be denoted with like reference numerals.

The mechanism 11 is shown in a lowered tamping position, where the tamp 14 sits inside a basket 42 of a portafilter 40. The mechanism 11 includes a linkage 30 in the form of an arm 86 connected to a rod 102 of an actuator 13 in the form of a linear drive shaft 103 which moves up and down through support 104.

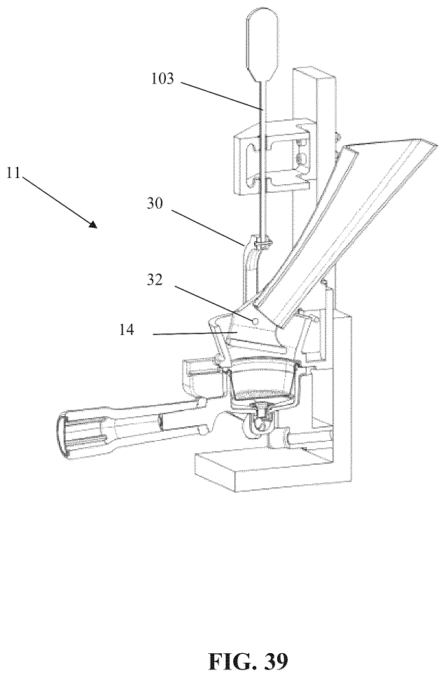

FIG. 39 shows the mechanism 11 in an intermediate position, where the shaft 103 has been operated to lift the linkage 30 and simultaneously pivot the tamp 14 about rotary coupling 32. The tamp 14 is connected to the arm 86 by a rotary coupling on both sides of the tamp 14 while the arm 86 itself bridges over the chute 21 so as to avoid any interference between the arm 86 and the chute 21 when the shaft moves the mechanism 11 between raised and lowered positions.

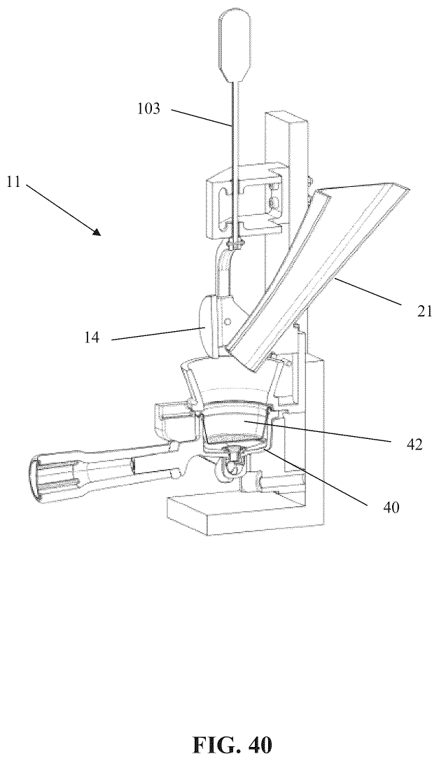

In FIG. 40, the mechanism 11 is in a raised position, where the shaft 103 has been lifted and the tamp 14 is rotated clear of the chute 21. In that position, coffee can be dispensed centrally of the tamp chute 23, via the centrally located chute 21, and directly into the basket 42 of the portafilter 40, without obstruction. More importantly, the chute 23 is centrally located relative to the portafilter 40 so coffee grounds are delivered centrally of the basket 42.

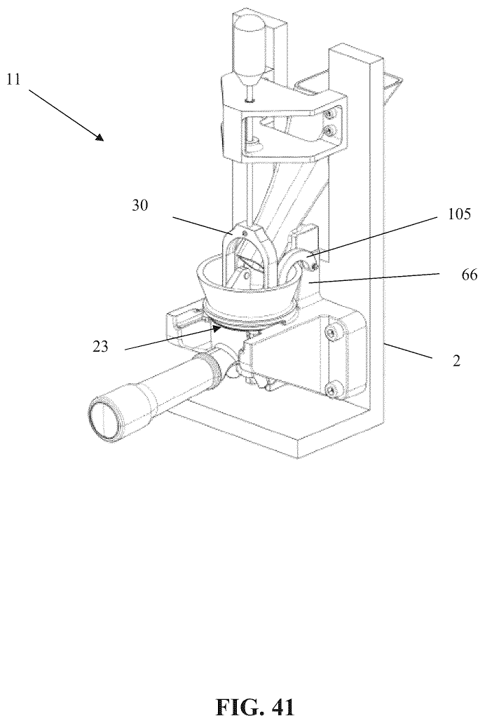

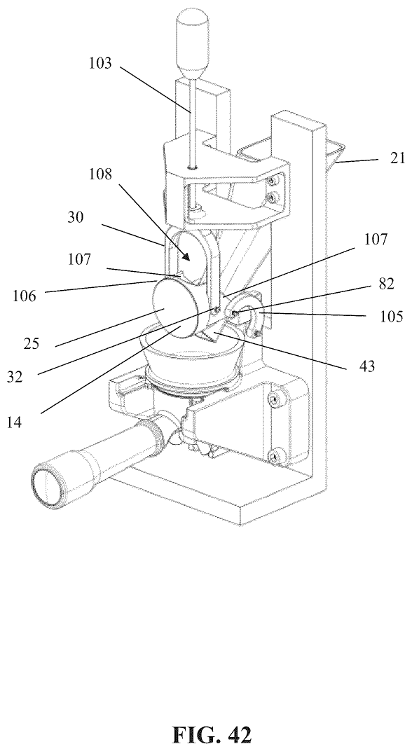

FIG. 41 is a perspective view of the mechanism 11 in the lowered position. A second linkage 105 is provided which is hinged to the fixed structure 66 adjacent an tamp chute 23 of the tamping unit 2. The linkages 30, 105 work in unison to move the tamp 14 between the tamping position shown and the raised position illustrated in FIG. 42.

More particularly, the second linkage 105 is connected to the tamp 14 via pivot 82 and the linkage 30 is connected to the tamp 14 through the rotary coupling 32 which is intermediate tamp face 25 and the pivot 82, to allow the tamp 14 to be pivoted between different tilted orientations as the linkage 30 is moved in a linear direction relative to the hinged second linkage 105.

Linear upward movement of the drive shaft 103 results in the tamp lifting and rotating clear of the lower end 43 of the grind chute 21, while linear downward movement of the shaft 103 causes the tamp to rotate back to the tamp position shown in FIG. 41.

FIG. 42 also more clearly shows the tamp 14 as having a body 106 and two side portions 107 that carry the respective pivot 82 and rotary coupling 32. The side portions 107 project away from the body 106 to define a space 108 therebetween which provides clearance around the grind chute 21 during rotation of the tamp 14.

### Example 5

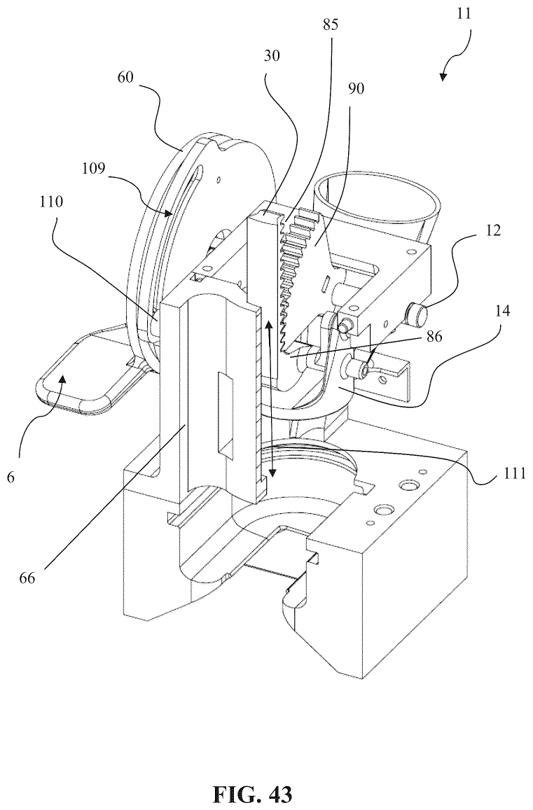

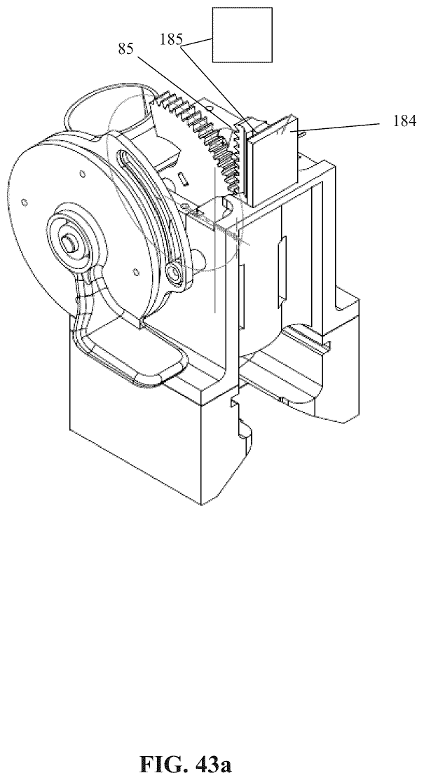

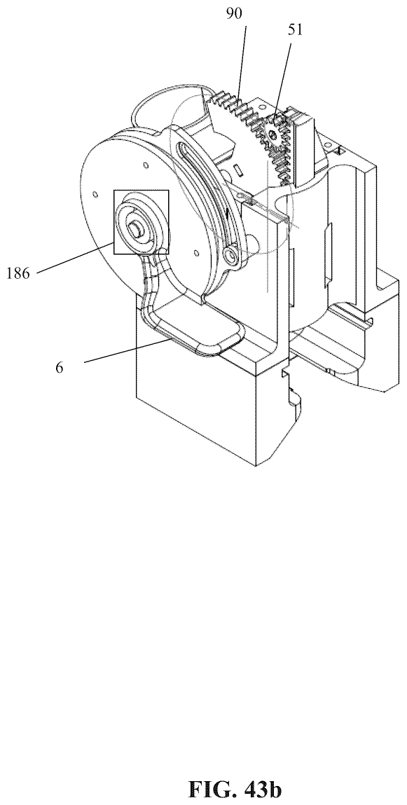

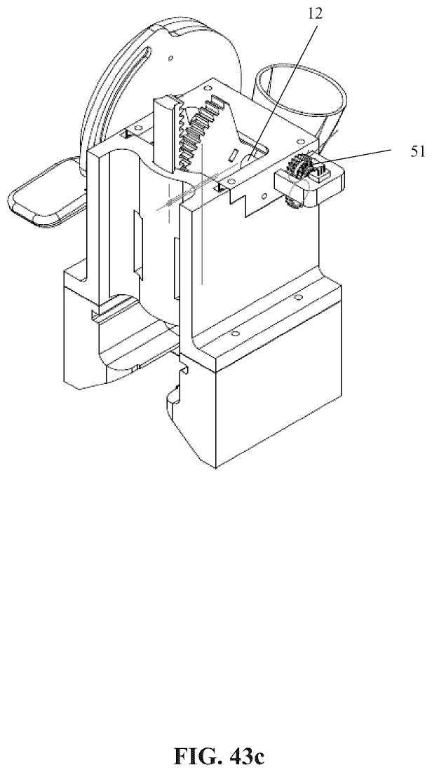

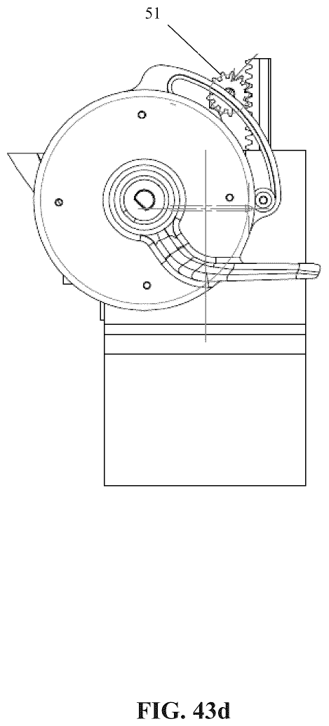

FIG. 43 illustrates another example of a tamping mechanism 11 and like parts will be denoted with like reference numerals to those used above.

The mechanism 11 is shown as including a linkage 30 in the form of a rack 85 which is driven by a pinion 90 attached to a drive shaft 12. The rack 85 is connected to a tamp 14 via an arm 86 and a rotary coupling 32 such that a tamp 14 is moved up and down in a linear manner indicated by directional arrow when the rack 85 is lifted and lowered by rotation of the shaft 12.

The shaft 12 is operated by a lever 6 through a clutch 60. The clutch 60 includes an annular slot 109 which receives a pin 110 that projects from fixed structure 66 to allow the clutch limited rotational movement in unison with the lever 6.

It may be appreciated the clutch 60 may be used in combination with the other examples of machines 1 described above.

The relative position of the lever 6 and tamp mechanism 21 can be monitored by one or more different sensors, as required. FIG. 43a shows the location of a linear sensor 184 and Time of Flight (ToF) sensors 185, arranged to monitor the linear movement of the rack 85. Time of flight sensors calculate the distance between two points. In this case, the upper sensor 185 would be located in a fixed location. As an alternative to the upper sensor 185, a lower sensor 184 would be attached to the rack 85 so that the linear movements of the arm 86 can be measured.

Alternatively, a rotary sensor 51 may be employed in the position shown in FIG. 43b, to measure the relative rotation of the pinion 90. As a further alternative, a rotary sensor 186 could be located to directly monitor rotation of the lever 6.

FIG. 43c shows yet another option of a rotary sensor 51 mounted to the end of the shaft 12, while FIG. 43d shows another option of the rotary sensor 51 engaging with the rack 85 directly.

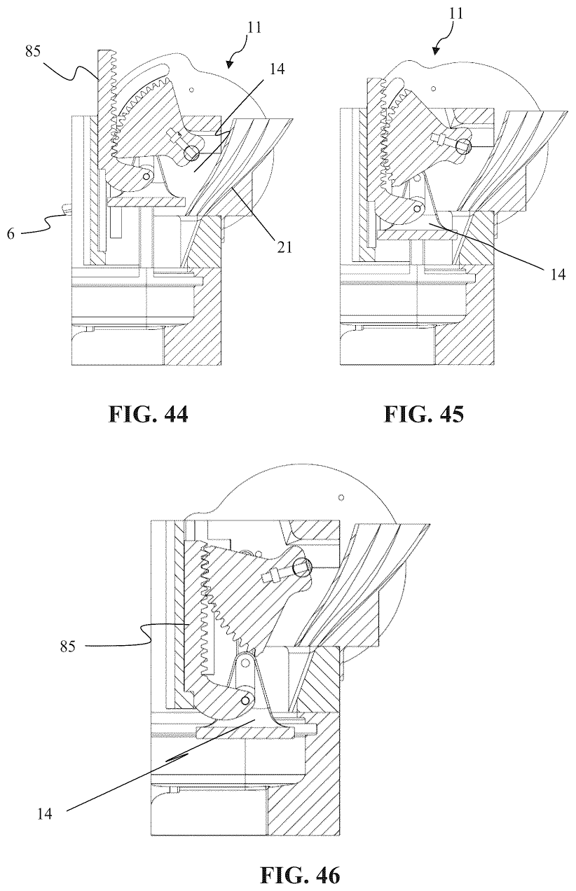

FIG. 44 shows the lever 6 in a home position and the mechanism 11 at the top of a stroke such that the rack 85 is elevated and the tamp 14 is in a rest position above and clear of a grind chute 21.

As the lever 6 is pressed down, the mechanism 11 lowers the tamp 14 through an intermediate position shown in FIG. 45.

At the end of the stroke, the rack 85 is in a lowered position and the tamp 14 is located in the tamping position shown in FIG. 46.

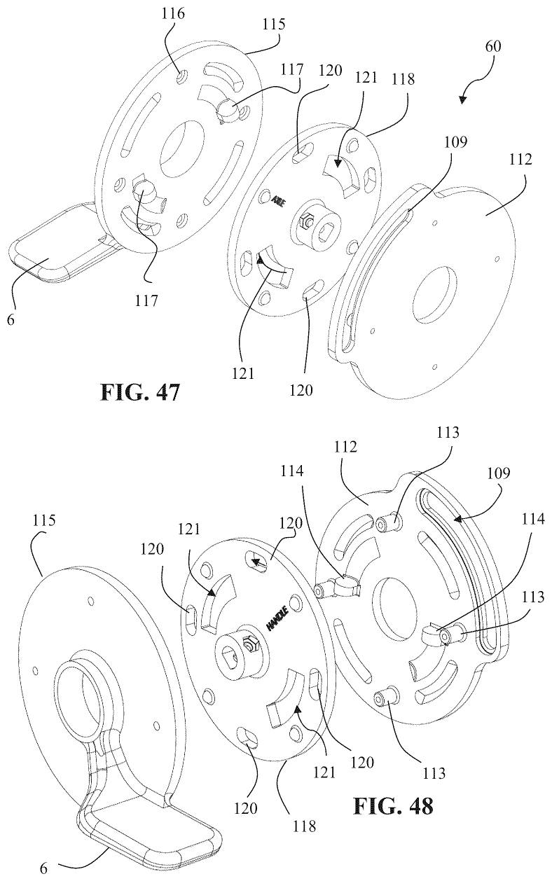

Moving to FIGS. 47 and 48, the clutch 60 is described in more detail. The clutch 60 includes a first disc 112, the annular slot 109, connection members 113 and biased elements 114. Preferably, the first connection members 113 are located radially outward of the elements 114. Preferably, the biased element 114 are rectangular bosses. Preferably the connection members 113 are cylindrical protrusions.

A second disc 115 is attached to the lever 6 and includes connection recesses 116 for receiving the connection members 113 of the first disc 112, to inhibit relative rotation between the first and second discs 115. The second disc 115 also includes bias elements 117. Preferably, the biased elements 117 are similar to the biased protrusions 114 but oriented in an opposite direction.

The clutch 60 also includes a clutch disc 118 with a central shaft receiving clamp 119 and a radial array of annular slots 120. The connection members 113 pass through the slots 120 which have an annular dimension sufficient to allow limited movement between the clutch disc 118 and the first disc 112 such that lifting the lever 6, for example, does not translate into any movement of the clutch disc 118.

The clutch disc 118 also includes two annular openings 121 to receive the biased elements 114 and 117 of the first and second discs 112 and 115, so that the first and second discs 112 and 115 are able to drive the clutch disc 118 and transmit torque from the lever 6 under pre-tensioned bias. The discs 112 and 115 in combination with the bias elements 114 and 117 thereby form a tamping force control assembly 15 to apply bias force during a tamping operation.

As may be appreciated from the above, an aspect of the invention is a machine 1 which, in one broad form, is a machine for delivering coffee grounds to a portafilter, the machine comprising: a grinder for grinding coffee grounds into the portafilter; a tamping mechanism for tamping coffee grounds in the portafilter along a path, the tamping mechanism comprising: a tamp comprising a surface for tamping coffee grounds; and a linkage connected to the tamp, wherein during a first portion of the path, the linkage causes the surface to orient in a first direction, and during a second portion of the path, the linkage causes the surface to orient in a second direction, wherein the first and second directions are different.

The invention also provides a machine for delivering coffee grounds to a portafilter, the machine comprising: a grinder for grinding coffee grounds into the portafilter; a tamping mechanism for tamping coffee grounds in the portafilter along a path, the tamping mechanism comprising: a tamp comprising a surface for tamping coffee grounds; a tamping actuator for moving the surface along the path, wherein during a first portion of the path, the surface is oriented in a first direction, and during a second portion of the path, the surface is oriented in a second direction, wherein the first and second directions are different.

The tamping mechanism moves the tamp through the first and second portions of the path between a rest position and a tamping position, where the surface is oriented in the first direction in the rest position, and in the second portion of the path the surface is oriented in the second direction for a tamping operation. In all the above examples, the linkage being is arranged to press a face of the tamp in an axial direction with respect to the portafilter during a tamping operation and return the tamp to a rest position between tamping operations along a non-axial path relative to the basket held in the portafilter such that the tamp does not obstruct delivery of the coffee into the chute when in the rest position.

The tamping mechanism rotates the tamp between the first and second portions of the path so that the tamp surface is oriented in the second direction for tamping coffee grounds during the tamping operation. In the above examples, the linkage returns the tamp to a rest position between tamping operations along a non-axial path relative to the portafilter such that the tamp does not obstruct delivery of the coffee into the portafilter when in the rest position.

The tamp is rotated in the rest position relative to the tamping position such that the tamp surface is oriented in the first direction which is angled away from the second direction whereby the tamp does not obstruct coffee grounds being delivered into the portafilter from the grinder.

### Tamp Example

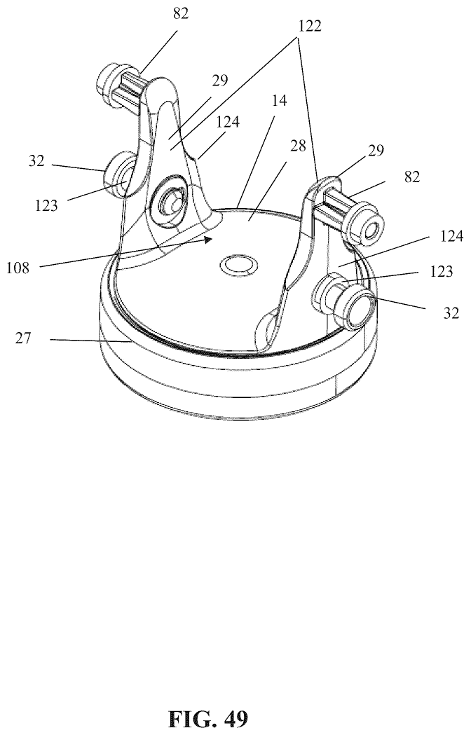

Turning now to FIG. 49, a tamp 14 is described and like parts to those described above will be denoted with like reference numerals.

The tamp has a base 27, a body 28 and a coupler 29 for connecting to the above described linkage 30. The coupler 29 includes support structure 122 that extends upwardly of the body 28. A transverse pin 123 provides a rotary coupling 32 for the tamp 14. A second pin 123 extends from an opposite side of the support structure 122 to provide a second rotary coupling 32.

A guide pivot 82 projects laterally of the tamp 14 in line with but in vertically spaced relation to an associated coupling 32. The guide pivots 82 extend laterally further from the support structure 122 than the couplings 32.

The support structure 122 is in the form of two spaced apart support members 124 which define a clearance space 108 therebetween.

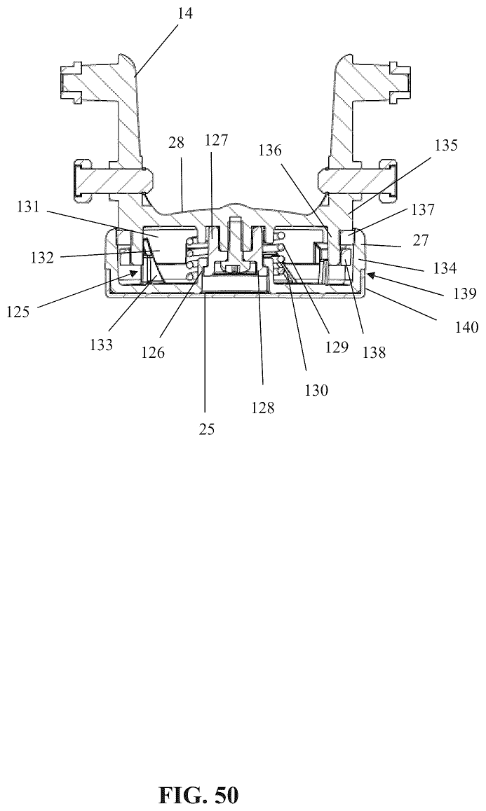

FIG. 50 is a cross-sectional view of the tamp 14 showing a rotating mechanism 125 that translates axial force into rotational movement of the base 27.

The base 27 has a collar 126 which slides up and down along a cylinder 127 fixed to the body 28 with a fastening screw 128. A biasing element 129 is positioned between the body 28 and the base 27. The biasing element 129 is preferably in the form of a spring 130 which is positioned over the collar 126 and connected between the base 27 and the body 28.

The rotating mechanism 125 includes cam structure 131 which generates the rotational movement of the base 27 when the base 27 is moved axially or telescopically with respect to the body 28. The cam structure 27 is in the form of a series or ramps 132 and respective projections 133.

The base 27 further includes a side wall 134 which slides up and down an outer wall 135 of the body 28 and the body 28 has a locating flange 136 to support a seal 137 which seals against the side wall 133 during relative axial movement. The flange 135 also carries a retaining ring 138 to hold the seal 137 in place.

The base 27 includes a circular rebate 139 in the side wall 134 to receive an attachment skirt 140 which supports a tamping face 25 underneath the base 27.

The tamp 14 is shown in an expanded state. As may be appreciated, when axial load is placed on the tamp 14, during a tamping operation, the tamp 14 compresses as the base 27 moves toward the body 28. During that axial movement, the ramps 132 and projections 133 engage and slide along each other to cause rotation of the base 27.

After a tamping operation, the axial load is removed and the spring 130 urges the base 27 away from the body 28, which causes the camming action to be reversed. This causes the base 27 to rotate in a reverse direction as the tamp 14 returns to the expanded state as a result of the ramps 132 and projections 133 reversing to the original orientation.

The rotational movement of the base 27 helps to “polish” the puck during tamping and provide a more even distribution of coffee grounds. Simultaneously, any coffee grounds that may have adhered to the tamp face 25 can be dislodged, which helps to clean the tamp 14 which is beneficial as a build-up of coffee grounds on the tamp 14 may otherwise the formation of an ideal puck.

The relative rotation of the base 27 of the tamp 14 in both directions serves to self-clean the tamp 14 and remove coffee grounds off the face 25 of the tamp 14 both during and after the puck is formed as the tamp base 27 rotates relative to the body 28 during tamping and again after the tamping operation when axial load on the tamp 14 is removed.

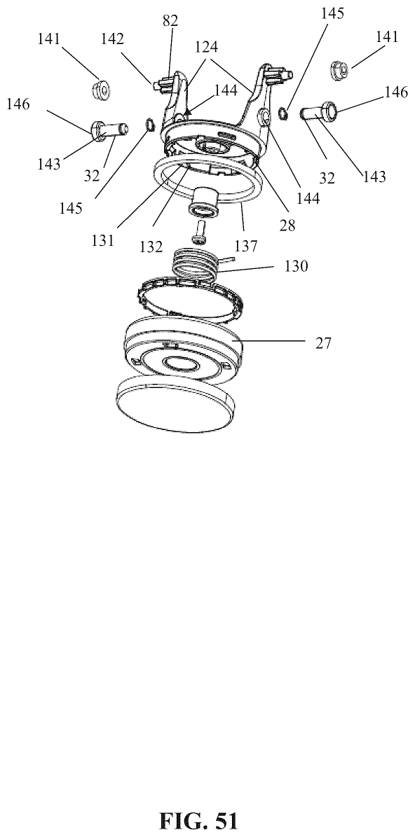

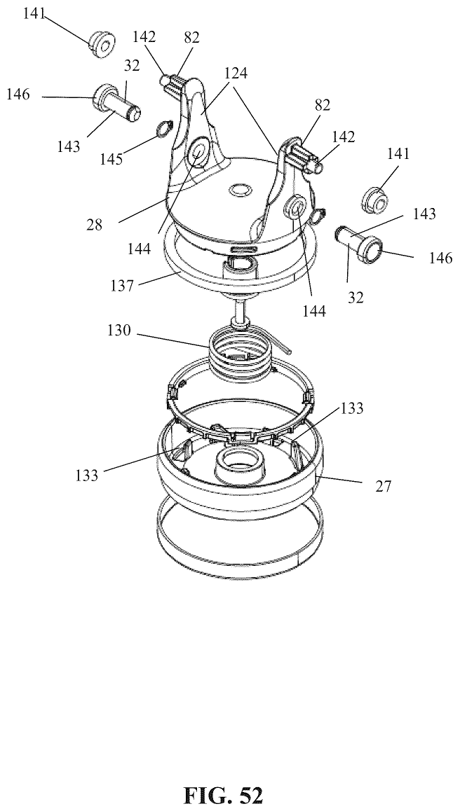

Turning now to FIG. 51, the cam structure 131 in the body 28 are more clearly shown as radially arranged ramps 132 which engage with the corresponding projections 133 formed in the base 27, as shown in FIG. 52.

FIGS. 51 and 52 also show the pivots 82 as being formed of ferrules 141 fitted to axles 142 integrally formed with the support members 124. The couplings 32 are formed of axles 143 which are inserted through openings 144 and held in place with circlips 145. The axles carry ferrules 146.

The tamp 14 is shown as having only a single spring 130 to bias the base 27 away from the body 28 however additional springs or alternative biasing means may be used, as required.

The tamp 14 of FIGS. 51 and 52 is also shown with the seal 137 which is preferably made of felt to stop coffee from entering the tamp 14 however the felt seal 137 may instead be replaced with any other suitable seal, as needed.

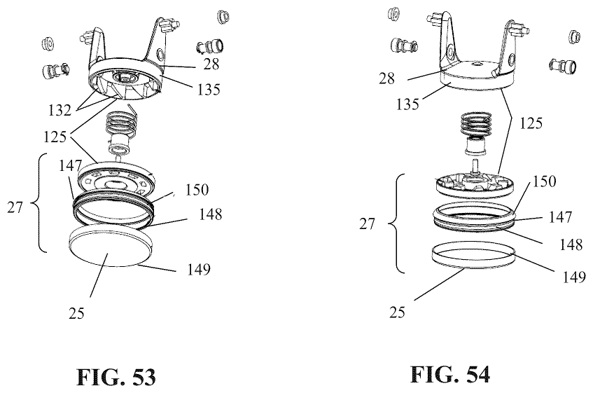

FIGS. 53 and 54 show an alternative tamp 14, where like features are denoted with like reference numerals. The rotating mechanism 125 again includes a series of ramps 132 on an underside of the body 28 and matching projections 133 in the base 27. The felt seal of FIGS. 51 and 52 is replaced with a rubber seal 147 which has an inner ring 148 that fits inside a base cover 149 and an annular shoulder 150 arranged to slide up and down the circumference of the outer wall 135 of the body 28. The base cover 149 defines the tamp face 25.

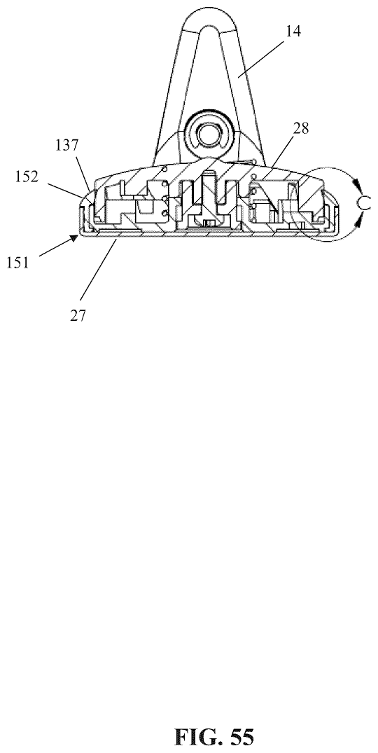

FIG. 55 shows the seal 137 is in the form of a blade which is mounted in an annular groove 151 in the base 27. The seal 137 is preferably formed of rubber such that the seal 137 presents a rubber wiper blade 152 which is more durable than many other alternatives.

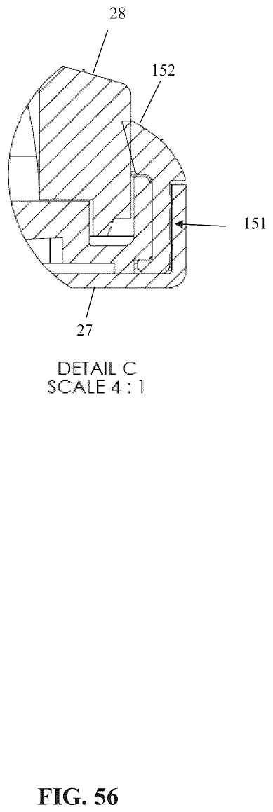

As shown in FIG. 56, the wiper blade 152 is resiliently pressed against the outer wall 135 of the body 28. The body 28 is preferably formed of plastic and the connection of the blade 152 and the wall 135 is a point contact which reduces friction while ensuring a tight seal as the tamp 14 is compressed and decompressed during and after a tamping operation. The body 28 is preferably also formed of higher density plastic to that there is minimal friction between the blade 152 and body 28.

The tamp 14 of any one of FIGS. 49 to 56 preferably also includes a breather hole to allow pressure inside the tamp to equalise during compression of the tamp. The breather hole is preferably located adjacent to a top region of the body 28 where coffee grounds ingress is unlikely to occur. For example, it may be located on the support structure 124 or item 108.

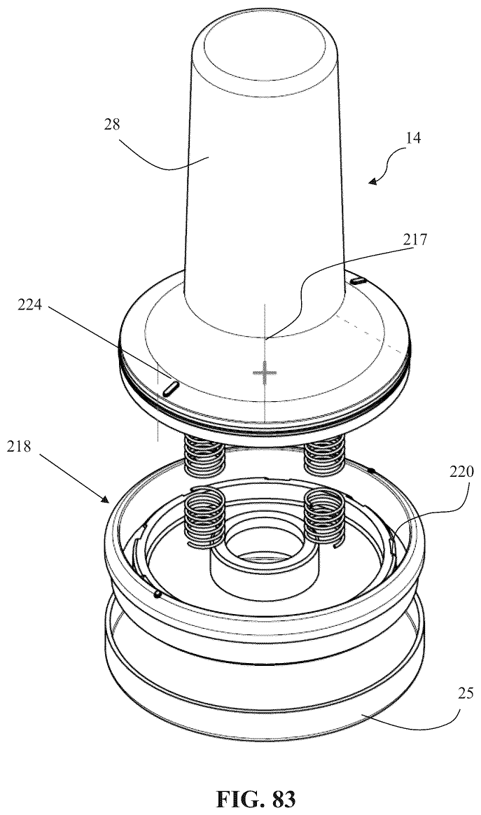

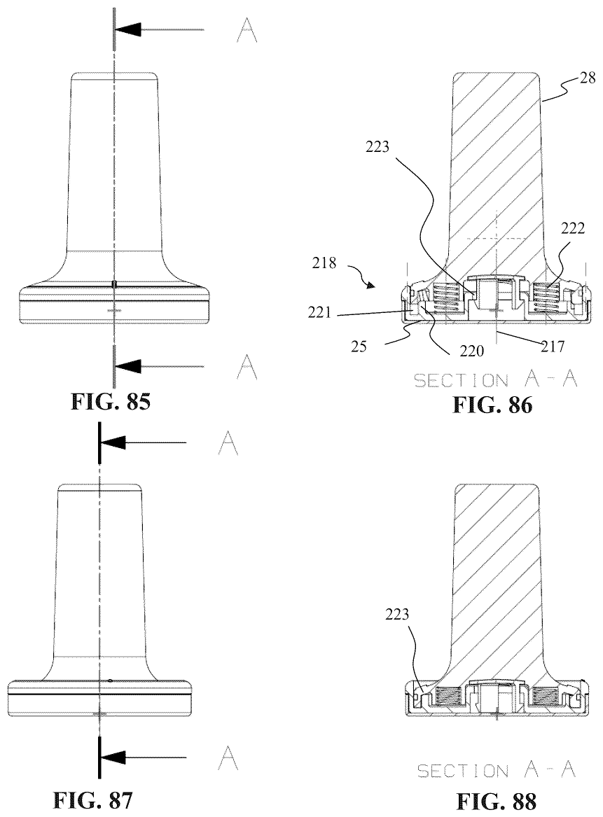

FIGS. 83 to 90 relate to another example of a tamp 14 and like reference numerals are used to denote like parts, where appropriate. It should be noted any of the various forms of tamp 14 described above may be used as a manual tamp separate of the above described machine 1.

As shown in FIG. 83, the tamp 14 has a body 28 with a central axis 217. The tamp 14 also has a tamp surface face 25 to compress ground coffee in the portafilter 40. The tamp 14 further has a connecting assembly 218 located between the body 28 and the tamp face 25, and connecting the body 28 to the tamp face 25 such that pressure may be applied to the tamp face 25 through the body 28 and the connecting assembly 218. During a tamp, coffee grinds tend to stick onto the tamp face 25 and build up over time if not cleaned by the user. Inbuilt tamping mechanisms are more prone to this issue as the tamp surface 25 is not as accessible as it would be compared to a regular tamp. A rotating tamp 14 can reduce the amount of build-up on the tamp surface 25. To further improve the effectiveness of the rotating tamp 14, a non-stick surface or material on the tamp face 25 can be used in combination with the rotating tamp 14. The non-stick surface or material can also be used as an alternative to the rotating tamp 14.

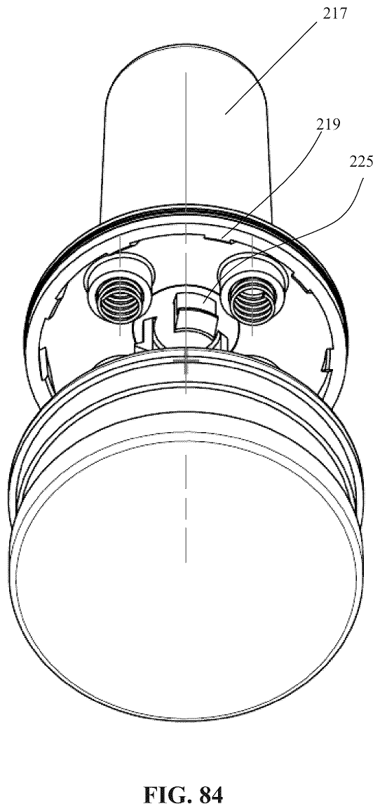

As better seen in FIG. 84, the connecting assembly 218 includes a first inclined surface 219 arranged about the central axis 217. Preferably, the first inclined surface 219 includes a plurality of inclined surfaces. As seen in the section view of FIG. 86 the connecting assembly 218 also includes a cam 220 adapted to abut the first inclined surface 219. Preferably, the cam 220 is a second inclined surface 221 arranged about the central axis 217. The connecting assembly 218 also includes a tamp bias member 222 connected between the tamp face 25 and the body 28 such that, when a distance between the tamp face 25 and the body 28 reduces, the tamp bias member 222 exerts a force urging the tamp face 25 and the body 28 away from each other.

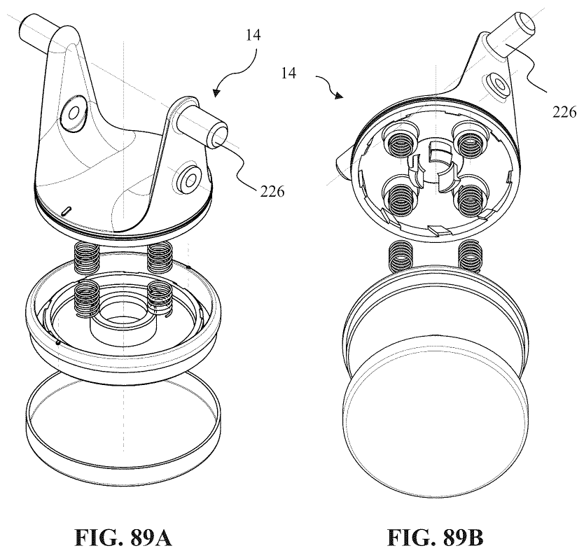

As seen in FIGS. 86 and 89, when a compressive force is applied to the tamp face 25, and the body 28 is held fixed, the tamp face 25 moves, preferably translates, toward the body 28 from a rest position, shown in FIG. 86, to a tamp position, shown in FIG. 88, thereby compressing the tamp bias member 222. When the tamp face 25 and the body 28 move relatively toward each other, the cam 220 abuts the first inclined surface 219, this abutment causes a normal force on the cam 220 from the inclined surface 219 and thus causes the cam 220, and the tamp surface 25, to pivot about the central axis 217 relative to body 28. When the compressive force to the tamp face 25 is removed, the tamp face 25 is urged away from the body 28 by the tamp bias member 222. As the tamp face 25 and the body 28 move away from each other, the cam 220 is similarly urged against the first inclined surface 219 and as the distance between the tamp face 25 and the body 28 increases, the cam 220 allows pivoting of the tamp face 25 about the central axis 217 back toward the rest position, thereby moving the tamp face 25 relative to the ground coffee in the portafilter. Preferably, the rotation of the tamp face 25 relative to the body 28 is about 5 degrees for about 3 mm of distance between the tamp face 25 and the body 28.

Preferably, the tamp bias member 222 has a pre-tension to urge the tamp face 25 toward the rest position. More preferably, the tamp bias member 222 also has a pretension to urge the tamp face 25 toward the rest position, both in axial translation relative to the body 28, and in rotation relative to the body 28.

As shown in FIG. 84, the first inclined surface 219 is preferably a helical spline. With reference to FIG. 86, the connecting assembly 218 may also include a stop member 223 adapted to prevent movement of the cam 220 along the first inclined surface 219 beyond the stop member 223.

In a preferred embodiment, the tamp 14 is sealed. An indicator 224 (as shown in FIG. 83) is provided which depicts the rotation of the tamp face.

In another preferred embodiment, the tamp face 25 is removably connected to the connecting assembly 218, for example by means of tabs 225 (shown in FIG. 84).

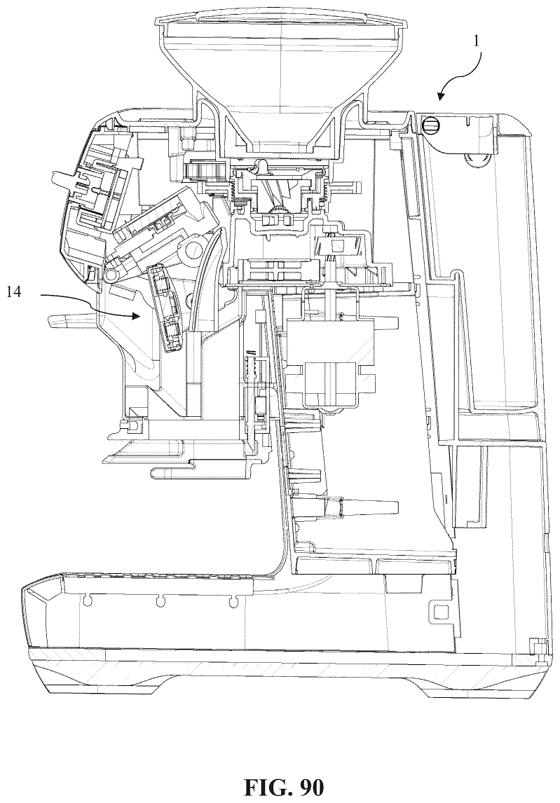

Referring now to FIGS. 89A and 89B, which show another embodiment of the tamp 14. The tamp 14 is substantially similar to the tamp 14 of FIGS. 88 to 88, however the tamp 14 of FIG. 89 is adapted to be used in the machine 1 herein disclosed, or another type of coffee grounds compacting assembly that involves a tamp. The tamper 14 of FIG. 89 includes a round pin 226, to be used in guiding movement of the tamp 14 as disclosed in this specification in relation to the pivots. As seen in FIG. 90, the tamp 14 may be used in the machine 1.

### Twin Track Dosing Unit

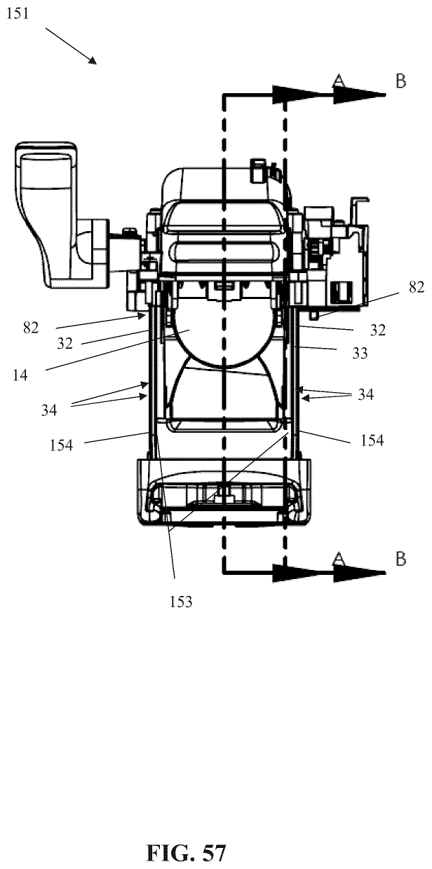

A dosing unit 2 is shown in FIG. 57, where like parts described above are referred to with like reference numerals.

In FIG. 57, the tamp 14 is shown in a rest position, prior to tamping. Guide structure 34 is provided in the housing 33 in the form of dual tracks 153, 154 to guide the respective couplings 32 and pivots 82 of the tamp as the mechanism 11 is raised and lowered.

As described above with reference to FIGS. 49 and 50, the pivots 82 project outwardly of the tamp 14 by a greater distance than the lower couplings 32, so the upper pivots 82 can be guided by the tracks 154, while the tracks 153 are used to guide the lower couplings 32. The pivots and couplings can be independent guided by dual tracks as a result of the geometry (e.g. depth, and/or width) of the tracks 153, 154 and the pivots 82 and the couplings 32. The geometry of the couplings 32 matches the geometry of the tracks 153, likewise the geometry of the pivots 82 matches the tracks 154. For example, the width of the tracks 153, 154 matches the diameter of the couplings 32 and pivots 82 respectively.

By independently guiding the pivots 82 and the couplings 32, the tamp 14 can be readily rotated into and out of the rest position without following a wrong path (e.g. the tamp 14 may otherwise be rotated in an opposite direction so as to block the grind chute).

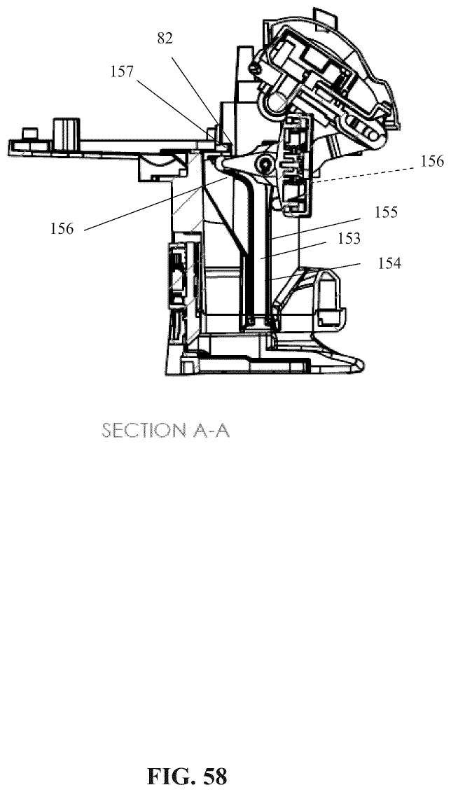

FIG. 58 shows the tracks 153, 154 aligned and parallel along a lower portion 155 and diverging at a respective upper portion 156, 157. The pivot 82 is in the upper portion 157 of the track 154 and the coupling 32 is located in the respective upper portion 156 of the outer track 153. When the rollers are positioned in that manner, the mechanism 11 is in the raised position and the tamp 14 is rotated so the face 25 is tilted to a near vertical orientation so as to give clearance to the grind chute 21.

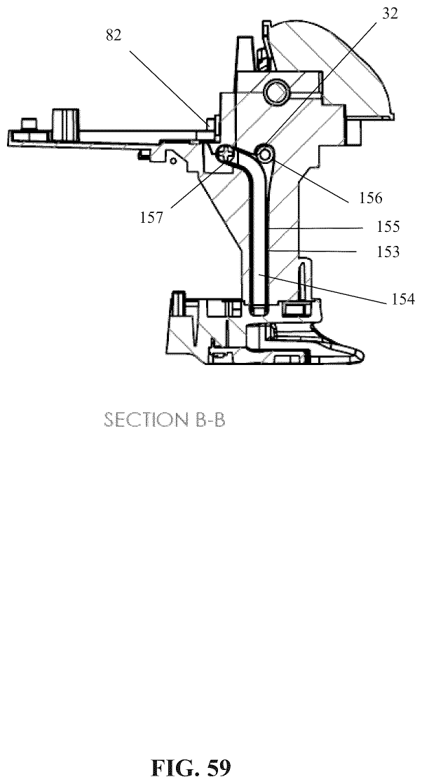

FIG. 59 illustrates the relative positions of the coupling 32 and pivot 82 in the upper portions 156, 157 of their respective tracks 153, 154. The upper portions 156, 157 of the tracks 153, 154 are curved away from each other in a horizontal direction so that the coupling 32 and pivot 82 adopt a near horizontal orientation so as to give clearance to the grind chute 21.

For tamping, the coupling 32 is guided out of the upper portion 156 of the track 153, down to a vertically oriented lower portion 155 of the track 153. The pivot 82 is simultaneously guided out from the upper portion 157 of the track 154 and then down the vertical portion 155 of the track 154.

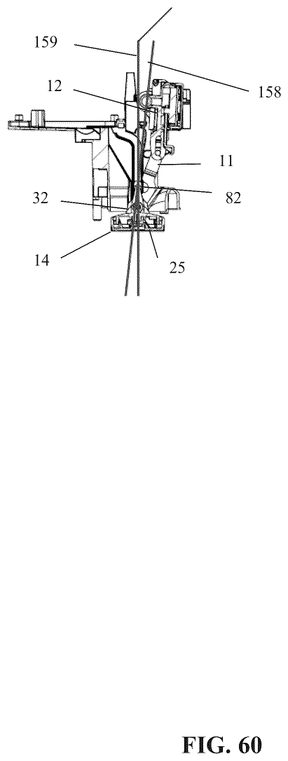

FIG. 60 shows the mechanism 11 extended and the coupling 32 and pivot 82 vertically oriented in their respective tracks 153, 154.

In that position, the tamp 14 is ready for tamping. A centre line 158 of the mechanism 11, taken through the centre of the shaft 12 and the coupling 32 is angled away from vertical indicated by vertical line 159, which assists in angling the face 25 of the tamp 14 more toward vertical when the tamp is lifted into the rest position and that in turn provides improved clearance so that tamp 14 does not obstruct the flow of coffee grounds during a dosing operation.

The use of dual tracks 153, 154 provides a benefit that each pivot point of the tamp 14 can be controlled independently for smooth motion and fast rotation when the mechanism is at a top of a stroke, to quickly move the tamp 14 into a rest position and away from obstructing the flow of coffee during the dosing operation.

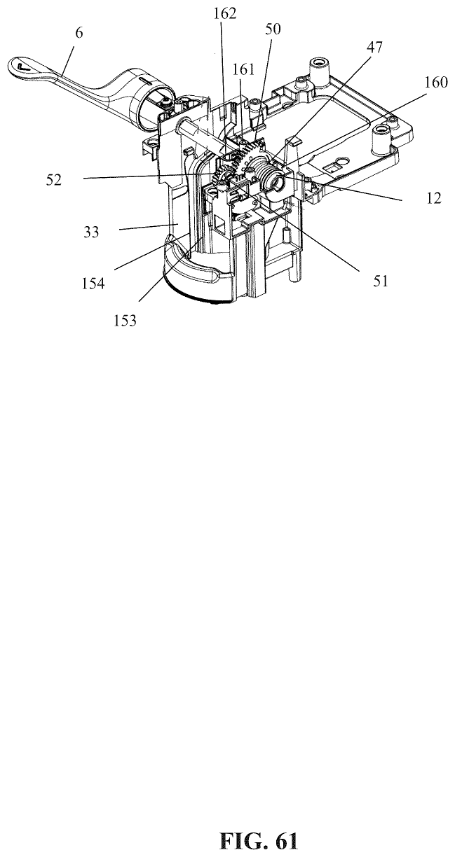

FIG. 61 more clearly shows the tracks 153, 154 formed in the housing 33. FIG. 61 also shows another example of a return device 47, in the form of a torsional spring 160, is mounted to the end of the shaft 12. The spring 160 is biased to return the lever 6 toward the home position after a tamping operation.

A sensor 51 is used to detect the relative rotation and position of the shaft 12 during the tamping operation. The sensor 51 monitors the shaft rotation through a cog 52 which meshes with a control gear 50 attached to the shaft 12. The gear 50 has teeth 161 only over a limited section 162.

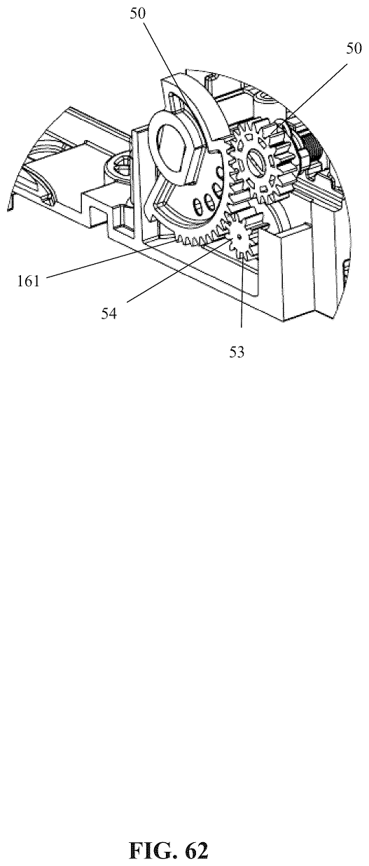

A damper 53 is provided under the sensor 50, as shown in FIG. 62. The damper 53 is in the form of a cog 54 which meshes with the teeth 161 of the gear 50 and resists rotational movement of the gear 50. The damper 53 is disengaged from the control gear 50 when the lever 6 of FIG. 61 is in the home position, since the teeth 161 are provided on a limited section 162 only of the gear 50. Pressing the lever 6 down will cause rotation of the gear 50 and eventual connection of the teeth 161 with the damper 53. The action of the damper 53 on the gear 50 can thereby be restricted to the end stroke of the lever 6, when the lever 6 is in a lowered position. None of the teeth on the gear are engaged when the lever is in the up position. As such, the damper is not engaged and only affects the rotation in the lower range of movement, which in turn reduces the strength (i.e. size) of the return device 47 as the return device 47 is not required to overcome the damper 53 at its lowest deflection (i.e. highest mechanism loading). The reduced. Reduced size of the return device 47 reduces the return speed of the tamping mechanism 11, which help minimize mess. Further, reduced size of the return device 47 can reduce the tamping force as required.

The damper 53 serves to reduce the speed of the tamping mechanism immediately before and after the tamping operation. This can help minimize mess such as may be caused by the tamp impacting the coffee grounds at speed on approach or by releasing from the puck at speed after the tamping operation, which could lead to the puck being loosened in the portafilter leading to poor coffee extraction.

### Portafilter Holder

The following is a description of the portafilter holder 7 and like parts to those described above will be designated with like reference numerals.

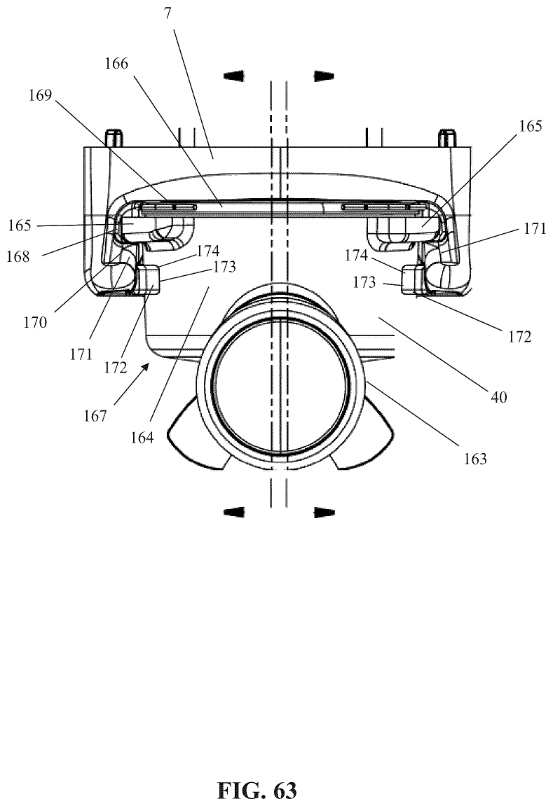

With reference now to FIG. 63, the portafilter 40 has a handle 163 attached to a cup portion 164 of the portafilter 40. Locating tabs 165 are arranged around the cup portion 14, adjacent an upper rim 165.

The portafilter holder 7 includes an access opening 167 and a dock 168 defined by top and bottom support surfaces 169, 170 that securely capture and hold the tabs 165 when the portafilter 40 is in the illustrated docked position.

Ramps 171 are provided either side of the opening 167 to guide the tabs 165 into the dock 168 and a retention member 172 is also provided to resiliently hold the portafilter 40 in the docked position. The retention member 172 is formed of two biased elements 173 which are preferably in the form of spring clips 174 although any other suitable gripping means may be employed, as required.

To load the portafilter 40 into the portafilter holder 7, the portafilter 40 is initially introduced into the opening 167 so that the tabs 165 engage the ramps 171. This assists in centering and aligning the portafilter 40. The handle 163 is then used to push the portafilter 40 against the biased elements 173, which separate to allow the insertion of the portafilter 40, after which the clips 174 close against the portafilter 40 to bias the portafilter 40 into the docked position.

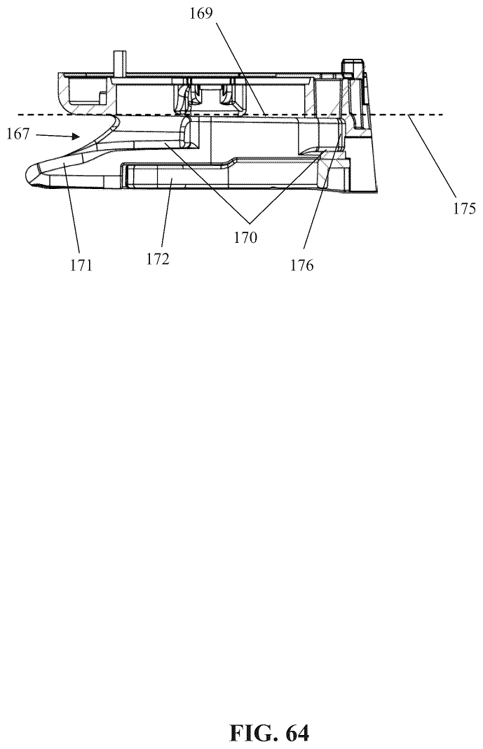

FIG. 64 is a cross-sectional view taken along the line G-G shown in FIG. 63, with the portafilter 40 omitted for clarity. The upper support surfaces 169 are angled slightly downward from a horizontal line 175, from the opening 167 to an end wall 176 of the dock in order to accommodate gravity lean on the portafilter 40 during insertion and/or tamping to provide front to back levelling of the portafilter to ensure the coffee puck is levelled during tamping. A microswitch or the like (not shown) can be positioned in or adjacent the wall 176 to detect when the portafilter 40 is loaded into the portafilter holder 7.

FIG. 64 also shows the location of the ramp 171 as being proximate the opening 167, in front of the retention member 172, so as to ensure the tabs 165 of the portafilter 40 are lifted into the dock 168 without interference form the retention member 172.

Conventional bayonet type portafilters have vertically off-set tabs and the lower support surfaces 170 lead up to support surfaces 171a (as shown in FIG. 64a) which are correspondingly vertically offset to ensure the portafilter is held horizontally when the portafilter is loaded into the dock so that the puck is levelled during tamping.

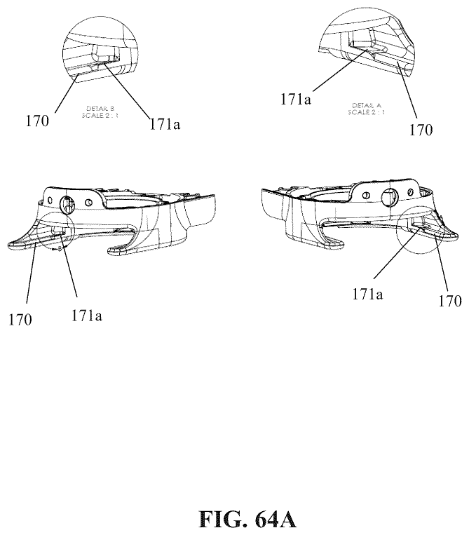

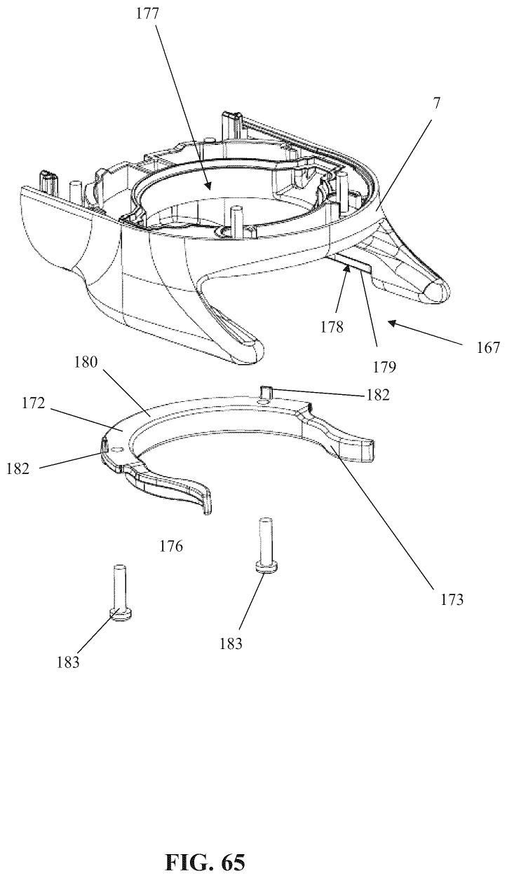

Turning now to FIG. 65, the portafilter holder 7 has an opening 177 to receive coffee grounds and a recess 178 on an underside 179 for holding the retention member 172. The retention member 172 has a generally U-shaped body 180 with a curved inner profile 181 to match the external shape of the cup portion 164 of the portafilter 40. The body 180 inserts into the recess 178 with the biased elements 173 projecting forward into to the opening 167. Locating tangs 182 on the body 180 ensure the retention member 172 is correctly orientated and positioned prior to the retention member 172 being fixed into the underside 179 of the portafilter holder 7 with fasteners 183.

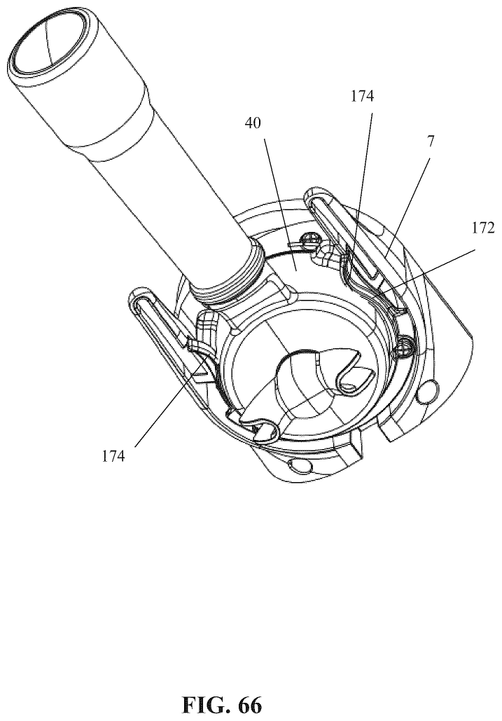

FIG. 66 shows an underside view of the portafilter 40 inserted in the portafilter holder 7. The spring clips 174 of the retention member 172 can be clearly seen holding the portafilter 40 in the docked position, ready for tamping.

As may be appreciated, the portafilter 40 can be reliably positioned and held in the portafilter holder 7 using a single insertion action and there is no requirement to lift and rotate the portafilter 40, as is normally needed with bayonet style portafilters. This helps simplify use and reduces the overall design height of the portafilter holder.

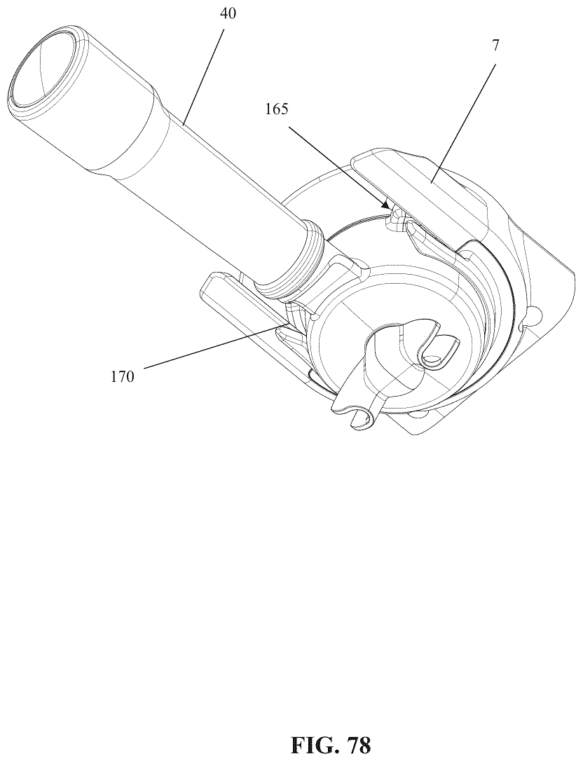

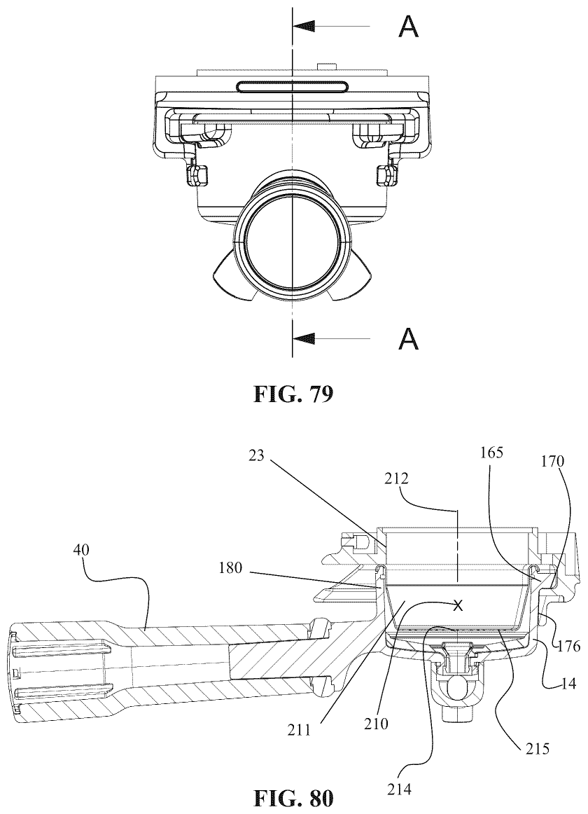

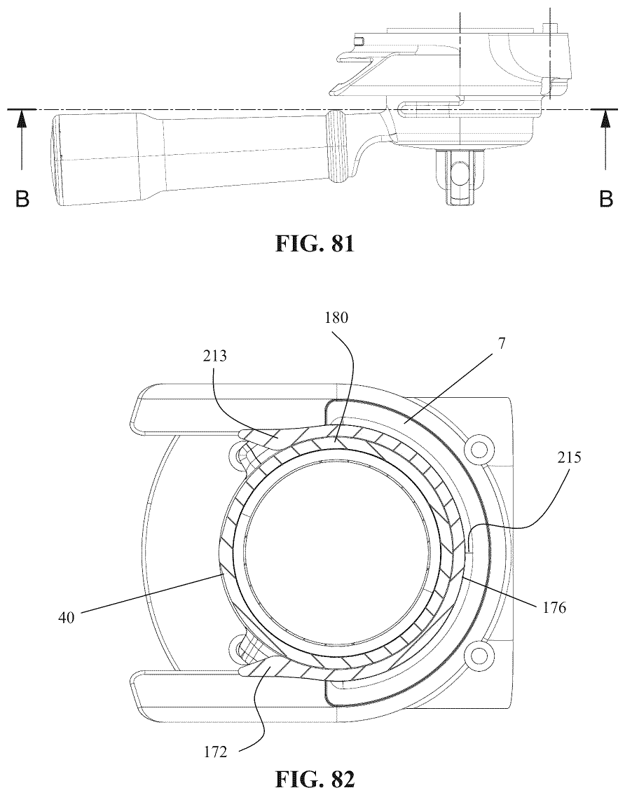

FIGS. 78 to 82 relate to a holder 7, where like parts to those described above will be denoted with like reference numerals.

As shown in FIG. 78, the holder 7 includes a support surface 170 for supporting locating tabs 165 of the portafilter 40. As better seen in the section view of FIG. 80, the holder 7 also includes a rear wall 176 shaped to conform to at least a cup portion 14 of the body 180 of the portafilter 40. The rear wall 176 is located such that, when the portafilter 40 abuts the rear wall 176, a center 210 of the filter cup 211 is aligned with a centre axis 212 of the tamp chute 23. As shown in FIG. 82, the holder 7 also includes a retention member 172 for urging the body 180 of the portafilter 40 to abut the rear wall 176. The central chute axis 212 is preferably normal to the filter cup floor 214 and projects through a center 214 of the filter cup floor 214.

The retention member 172 preferably urges the body 180 of the portafilter 40 by exerting a retention force on the portafilter 40. The retention force is preferably parallel to the support surface 170. Further, the rear wall 176 preferably includes a portafilter detection switch 215 (as shown in FIG. 82) for cooperating with the portafilter 40 to provide a portafilter signal indicative of a presence of the portafilter 40 in the holder 7.

The retention member 172 preferably exerts the retention force by resiliently deforming from a position that interferes with a position of the portafilter 40 when the portafilter 40 abuts the rear wall 176. The tendency of the retention member 213 to resiliently deform back to the position urges the portafilter 40 against the rear wall 176. In another embodiment, the retention member 213 includes a spring (not shown) with a pre-tension to exert the retention force. Preferably, the holder 7 includes two retention members 172 located at opposite sides of the holder 7, and therefore the portafilter 40 when held by the holder 7. Preferably, the retention members 172 are located in a plane parallel to the support surface 170 but vertically below the support surface 170.

### Coffee Grinding System

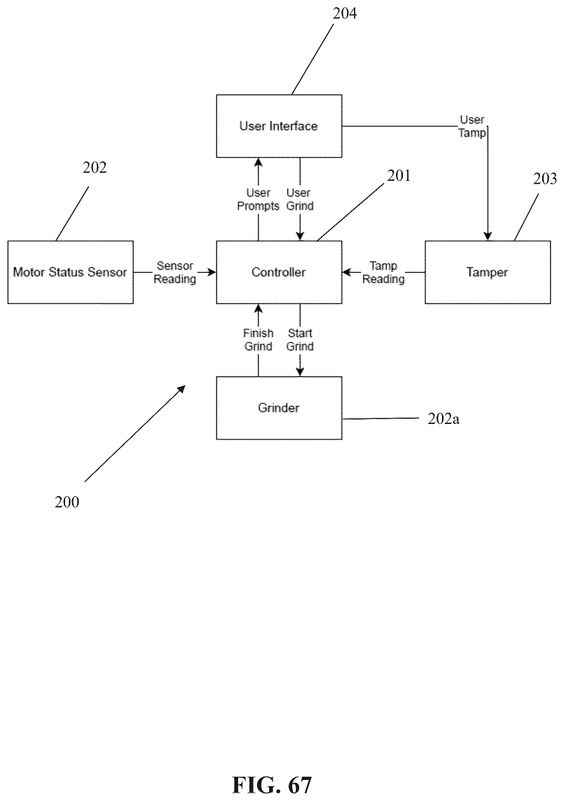

FIG. 67 is a schematic representation of a system 200 used to operate the above described machine 1. The system is designed to implement a method of delivering coffee grounds into a portafilter fitted to a machine for grinding coffee including determining a pre-determined grind to provide the coffee grounds, applying a tamp to form the coffee grounds into a puck, and providing tamp position feedback to a user during and/or after a tamping operation.

The method preferably includes monitoring tamp depth and also preferably includes informing the user if any adjustment to the grind is needed. The method may further include determining if the tamp depth is within a predetermined tolerance and adjusting a grind time if the tamp depth is outside the pre-determined tolerance.

The system 200 includes a controller 201 and a motor status sensor 202, which provides information on either the current or the motor speed of the grinder, to indicate the presence of beans in the hopper and/or blockages.

The system 200 also includes a grinder module 202 which receives start and stop signals from the controller 201 and provides feedback to the controller 201 when the grind is complete.

A tamper module 203 is also provided to conduct a tamping operation and provide tamp position information to the controller.

Lastly, the system includes a user interface module 204 to facilitate user operation of the system. The interface module 204 provides the user with operational prompts and allows for the user to operate the grinder and conduct a tamping operation.

The system 200 is used to implement one or more of the dosage algorithms described below.

### Dosage Algorithm

With various examples of the tamp mechanism 11 described above, the tamp position is monitored and during a tamping operation a tamp depth can be determined. The tamp depth information provides feedback for the purposes of determining the appropriate dosage of coffee grind into the portafilter 40. For example, if the position of the tamp 14 during the tamping operation is too high or low the grind can be changed so that the current and/or next dosage is adjusted accordingly.

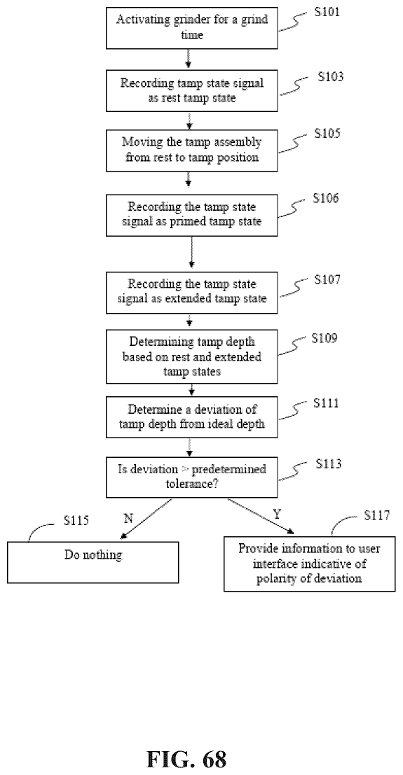

Referring to FIG. 68, an algorithm flow chart is shown which identifies some of the method steps taken to determine if any dosage adjustment is needed.

Step S101 represents an initial step of activating the grinder for a pre-determined grind, to produce a predetermined amount of coffee grinds. The predetermined amount of coffee grinds can be achieved by either using a pre-determined grind time or using a weight sensor to detect whether the predetermined amount of coffee grounds are delivered.

Once the grinder is activated coffee beans are ground in the hopper and transferred through the grind chute to the portafilter.

The tamp position is checked to be in the rest state at step S103, after which the tamp assembly is moved from the rest position to a tamp position at step S105. Tamping pressure is then applied to prime the tamp against the coffee grounds in order to form a coffee puck in the portafilter. The tamp state is recorded as primed at step 106 and the mechanism is also recorded as being in an extended state at step 107.

The total tamp depth is determined at step 109 by comparing the position information from when the tamp was in the rest state with the position of the tamp when the mechanism is in an extended state. A determination can then be made at step 111 as to any deviation between the tamp depth and an ideal depth.

If the deviation is smaller than a predetermined tolerance, no action needs to be taken and information can be provided to a user interface indicative of the ideal depth, as at step 115. However, if the deviation is greater than a predetermined tolerance, information can be provided to a user interface indicative of the polarity of the deviation, as per step 117. The dosage can then be adjusted for the current and/or the next use.

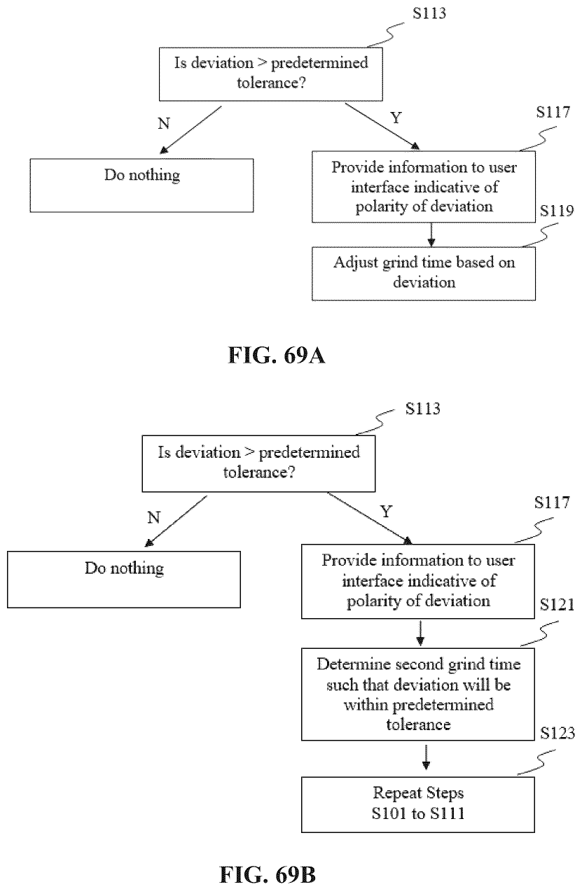

Regarding FIG. 69A, after step 117 the dosage may be adjusted by changing the grind based on the degree of deviation, at step 123 (as shown in FIG. 69B). The grind adjustment can be done either manually by a user or automatically.

FIG. 69B shows a case in which the deviation represents an underdose and a determination is made at step 121 to conduct a second grind to top up the dosage prior to extraction. Steps S101 to S111 are then repeated to ensure the tamp depth is within the pre-determined tolerance.

In relation to the measured tamp depth, this can be determined based on feedback from any suitable measuring sensor. If a rotary sensor and a linear sensor are used, the depth may be provided by:

$$depth = d = P - x$$

$$Where : x = R \cdot cos θ + L \cdot sin ϕ$$

$$and ϕ = {sin}^{- 1} ( \frac{R}{L} \cdot sin θ )$$

θ: Tamp state signal from rotary sensor (preferably difference between primed tamp state and extended tamp state)
R: Length of the first member 36 (including the movements in the connecting rod 19 as detected by the linear sensor 20)
L: Length of the second member 37
P: Ideal tamp depth

In one example, a preferable predetermined ideal tamp depth may be 6.75±0.5 mm. Tamp depths may be characterised as either underdosed or overdosed, depending on the amount of ground coffee deposited in the portafilter. An underdose such as shown in FIG. 10 may result in a tamp depth between 7.25 mm to 10 mm, while an overdose such as shown in FIG. 12 may result in a tamp depth between 1 mm to 6.25 mm. A severe overdose (e.g. tamp depth below 1 mm) requires removal of ground coffee before the portafilter can be used with the machine.

As seen in FIG. 69A, at step S119 a processor may adjust the grind for current and/or future grind operations on the basis of the deviation (when operating in an ‘auto mode’) or in response to a user input (if ‘manual’ mode is selected). In manual mode, the user may determine the grind on their own with reference to tamp depth measurements. The processor may not update the grind for further grind operations.

For a typical dosage operation, the adjustment calculation may be performed in auto mode using the linear relationship between the tamp depth and a pre-determined volume of a compressed coffee puck:

$$Volume [ \% ] = {c}_{1} * tamp depth [ mm ] + {c}_{2}$$

In one embodiment the values for c₁ and c₂ are −0.0638 and 1.4326, respectively, where the values for c₁ and c₂ may vary based on the geometry of the basket (e.g. single or double basket, basket with different diameters).

Using this relationship, the processor determines how much more or less volume is required in current and/or future coffee pucks. The adjustment to the grind may then be provided by the linear relationship between volume and grind time, which may be determined by the processor by dividing the determined volume by the current grind. The current and/or next grind is then determined by the reciprocal of this gradient.

The tamp depth calculation for a mechanism with an articulated linkage can also be derived in the following manner:

### Forward Kinematics and Denavit-Hartenberg (DH) Parameters

### Derivation 1—Liner Approximation

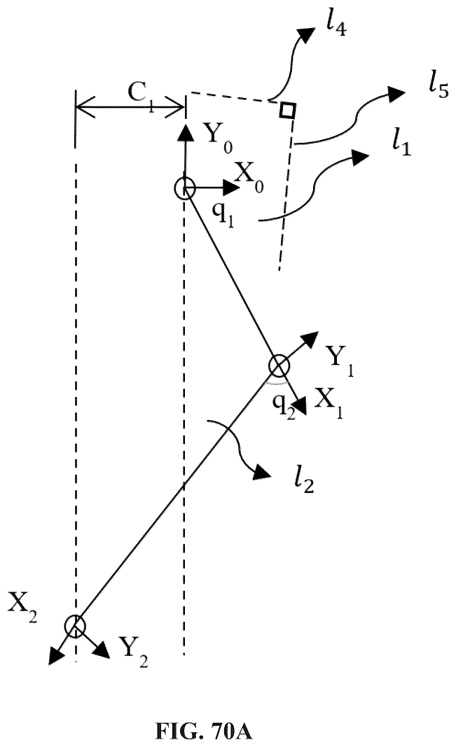

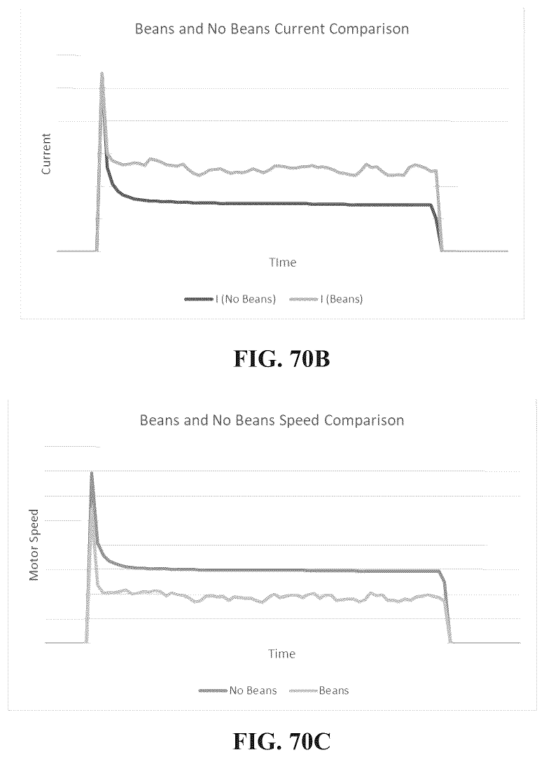

The mechanism 11 can be considered as a configuration of a two Degree-of-Freedom (DoF) planar manipulator on an x and y coordinate frame. FIG. 70A shows coordinate frames at different joints. Specifically, [x₀, y₀], [x₁, y₁], [x₂, y₂] represents the coordinate frame at the joint of the shaft 12, the joint of the first member 36 and the second member 37, and the rotary coupling 32 respectively.

That leaves us with the following equation to calculate the y coordinate.

$$y = {l}_{1} sin ( {q}_{1} ) + {l}_{2} sin ( {q}_{1} + {q}_{2} ) \qquad ( 1 )$$

We know the offset between the end effector and origin axis to be x=c₁ (It is negative based on the orientation above). As a result, we can get an equation to find q₂ based on any joint angle for q₁:

$$x = {c}_{1} = {l}_{1} cos ( {q}_{1} ) + {l}_{2} cos ( {q}_{1} + {q}_{2} ) \qquad ( 2 )$$

To derive a single equation to determine the y coordinate end effector, we can substitute q₂ into the equation for y:

$$y = {l}_{1} sin ( {q}_{1} ) + {l}_{2} \sqrt{1 - {( \frac{{c}_{1} - {l}_{1} cos ( {q}_{1} )}{{l}_{2}} )}^{2}}$$

In the preferred embodiment, the spring is located on the first member 36, so l₂ is a constant value, the only variables are l₁ and q₁. As previously discussed, a sensor 20 is provided which includes a connecting rod 19 and the relative position of the connecting rod 19 may be used to monitor the distance travelled by the tamp (l₃).

It should be noted that if the biasing element 7 is located on the second member 37, l₂ would be variable and l₁ would be a constant value. If the biasing element 7 is not in both of the first member 36 and the second member 37, l₃ may be eliminated (=0) from all equations.

The linear relationship of the distance monitored by the sensor 20 (l₃) and l₁ can be:

$${l}_{1} = {l}_{member 36} - {l}_{3}$$

This yields the equation:

$$y = ( {l}_{arm 134} - {l}_{3} ) sin ( {q}_{1} ) + {l}_{2} \sqrt{1 - {( \frac{{c}_{1} + ( {l}_{3} - {l}_{arm 134} ) cos ( {q}_{1} )}{{l}_{2}} )}^{2}}$$

Alternatively, the relationship of the first member 36 and the distance monitored by the sensor 20 can be non-linear. This relationship can be derived from trigonometry.

$${l}_{1}^{2} = {l}_{4}^{2} + {l}_{5}^{2}$$

Wherein l₄ is a constant value and l₅ represents the distance monitored by the sensor 20.

$${l}_{5} = {a}_{1} - {l}_{3}$$

The above two equations will yield a non-linear relationship between y and l₃.

### Simplified Calculations

To simplify the calculations, we can assume at the extended state we assume q₁=90°; q₂=0°, which means we can use the above equation to calculate tamp height based on the linear sensor 20 without measurements from the rotary sensor.

In this way, the linear relationship between y and 13 can be yielded:

$$y = {c}_{2} - {l}_{3}$$

Derivation 2-Denavit-Hartenberg (DH) parameters (an alternative derivation that is unique in itself. DH is normally used for robotics/robotic arms. It also derives the rotation and point of each of the links at any positions and can be used to derive the force equations too)

$${q}_{2} = {cos}^{- 1} ( \frac{{c}_{1} - {l}_{1} cos ( {q}_{1} )}{{l}_{2}} ) - {q}_{1}$$

With q₂ found (from equation (1) & (2)), we can now get the Denavit-Hartenberg (DH) parameters for the mechanism. To test these two equations, the values for l₁, l₂, q₁ and q₂ are put into a DH calculator to find the transformation matrix from one coordinate frame to the next.

$${M}_{n - 1 , n} = {}_{}^{n - 1} . {T}_{n}^{} = [ \begin{matrix}cos {q}_{n} & - sin {q}_{n} cos {α}_{n} & sin {q}_{n} sin {α}_{n} & {l}_{n} cos {q}_{n} ( i . e . x ) \\ sin {q}_{n} & cos {α}_{n} cos {q}_{n} & - cos {q}_{n} sin {α}_{n} & {l}_{n} sin {q}_{n} ( i . e . y ) \\ 0 & sin {α}_{n} & cos {α}_{n} & {b}_{n} ( i . e . z ) \\ 0 & 0 & 0 & 1\end{matrix} ]$$

Wherein y is the movements of the first member 36 (or the second member 37 if the biasing element 7 is located in the second member 37).
q: Rotation about z-axis
l: Distance on the z axis
b: Length of each common normal (Joint offset)
α: Angle between two successive z-axes (Joint twist)

### Dosage Algorithm Incorporating Grinder Status Detection

This dosage algorithm is based on two main parts: the tamp reading and the current grind. When a user tamps, the height of the tamp is measured and if the puck is not at the ideal height the length of time for the current and/or next grind is updated accordingly. If the above described system 200 detects an underdosage, the grind will increase and if an overdosage is detected, the grind will decrease.

During a grinding cycle, if the hopper runs out of beans and/or the grinder is blocked and the grinder continues until it finishes its set time, the user will tamp and receive an underdose reading (assuming it would have been an ideal dosage otherwise). This results in the algorithm trying to overcompensate by adding more time to the current and/or the next grind. When the user fills up the hopper again and tries to grind, they will receive an overdose in the current and/or the next tamping operation as the algorithm tried to compensate for the underdose that should have been an ideal dose.

This problem gets worse if the dosage was going to be an overdose, but the hopper ran out of beans and/or the grinder is blocked during a grinding cycle. If the height reading was an underdose again, the grind would update itself to a severe overdose.

By having a sensor to detect beans in the hopper and/or any potential grinder blockage, the grinder can be stopped if no beans are present and/or the grinder is blocked. This stops the grind from being completed unless there are beans present and updates the grind for the algorithm accordingly. This way, when the grind is completed the algorithm will adjust correctly so that the current and/or the next grinding cycle yields an ideal dosage. This removes any chance of errors in the algorithm caused by running out of beans.

An optional or an alternative step is that the grinder status can be checked prior to grinding so as to allow the user to i) refill the hopper if the hopper is empty; and ii) check the grinder if the hopper is blocked.
1) Grinder status detection method
   a) Normal & empty & blockage status of the hopper via current sensing.
      This method relies on the electric current drawn by the grinder. The current when beans are present will be greater than the current when no beans are present, as shown in Figure. 70B. The threshold to turn off the grinder will be slightly above the ‘no beans’ current draw. If the current is higher than the current when beans are present, the grinder is blocked and will be turned off.
   b) Normal & empty status of the hopper via speed sensing.
      A similar comparison to the above can be based on the motor speed of the grinder, which differs depending on whether there are beans in the grinder, as indicated by FIG. 70C.
2) How the grind is updated
   a) If the hopper is empty or the grinder is blocked during a grinding cycle, storing the actual grind time T1.
   b) Assessing remaining T2 against nominal T0 and completing T2.
   c) If the user refills the hopper after T1, a sub-interval T3 prior to T2 is added.
      T3 is considered as a ‘zero-flow-rate time’ of coffee beans as there are no beans between the burrs of the grinder after the empty hopper is refilled with beans because the beans need to travel down from the hopper.

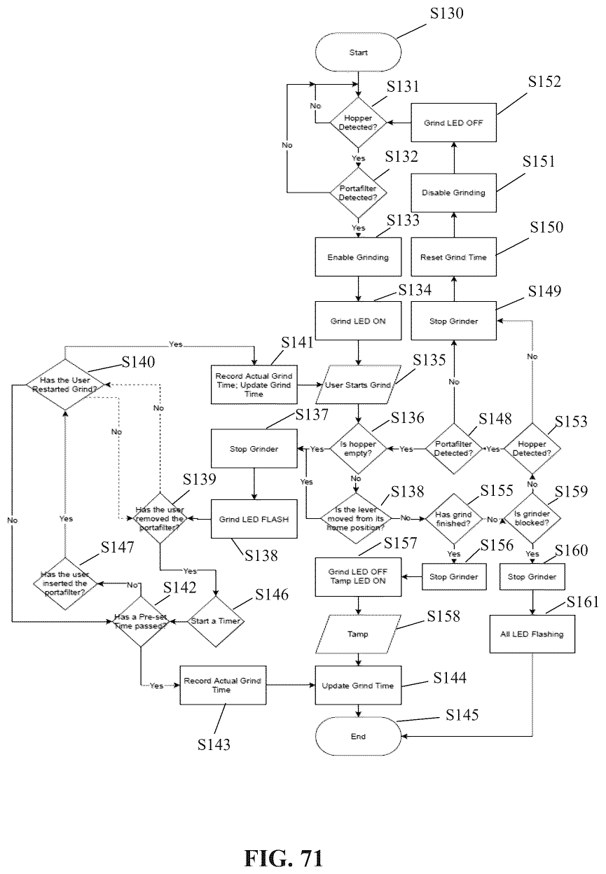

FIG. 71 is a flow chart of the algorithm steps where S130 represents the start of the algorithm and step S131 is a determination of whether a hopper is detected followed by the detection of a portafilter at step S132.

If both the hopper and portafilter are detected the grinder is enabled at step S133 and a grinder LED is illuminated to indicate the grinder is on at step S134. The user is then able to start the grind at step 135 such as by lifting the lever of the machine.

A check is then conducted to determine if there are beans in the hopper at step 136. If the hopper is empty the grinder is turned off at step S137 and the grinder LED is put to flash at step 138. A check is made at step S139 to ascertain if the user has removed the portafilter.

If the portafilter remains in the portafilter holder it is likely the user has re-filled the hopper with beans so a check of whether the user has restarted the grind is made at step 140. If the user has restarted the grinder, the actual grind time up until the grinder was stopped needs to be recorded and the remaining grind time needs to be updated at step S141, after which the process reverts to step S135.

If the user does not restart the grind, a pre-set time is checked at step S142, after which the actual grind is recorded at step S143 and an update of the grind time is made at step 144, after which the algorithm ends at step S145.

If the user removes the portafilter after an interrupted grind, a timer is started at step S146. If the pre-set time is determined as not having been reached at S142, and the portafilter is detected at step S147 as having been inserted back in the portafilter holder, the process reverts to step S140. Alternatively, if the pre-set time has passed, steps 143 and 144 are undertaken to update the grind.

It is of course important that the grinder not be operated if there is no portafilter in the portafilter holder. As such, if no portafilter is detected at step S148, the grinder is stopper at step S149, the grind is reset at step S150 and the grinder is disabled at step S151, followed by the grinder LED being turned off at step S152.

A similar process of turning the grinder off is undertaken if no hopper is detected at step S153. If a hopper is detected, as well as a portafilter at step 148, the process reverts to a check of whether the hopper is empty at step 136.

At step 154, the position of the lever is checked. If the lever has been moved from its home position the grinder may be stopped through the process of step 137. If the lever position is unchanged, a check is made at step S155 as to whether the grind is finished.

If the grind is complete, the grinder is stopped at step S156. The grind LED is turned off and a tamp LED is turned on, indicating the system is ready for the tamping operation.

Step S158 indicates the tamping operation. The grind is updated after the tamping operation, followed by the process ending at step 145.

Another important step in the above process is to maintain a check on any blockage in the grinder. This is done at step S159. If a blockage is detected, the grinder is stopped at step S160 and LED lights on the user interface are made to flash at step S161 to indicate the blocked state of the grinder. If the grinder is not blocked, the system can continue to monitor the status of the hopper and portafilter at steps S136, S148 and S153.

### Basket Size Check

One of the error scenarios for the manual tamp system is that the user can incorrectly select the wrong basket size setting for dosing operation. This would i) update the next grind for the next cycle incorrectly; and ii) add incorrect grind time to the current cycle.

In the case where a single basket setting for dosing operation has been selected but a double basket is used, the resultant volume of coffee provided into the portafilter will be severely underdosed. To correct the error, a significantly longer grind is needed.

Conversely, if a double basket setting has been selected but a portafilter with only a single dose basket is used, the amount of coffee provided into the portafilter will be severely overdosed and require the portafilter to be removed and cleared of the excess coffee.

A similar problem exists if two or more grinding cycles are conducted on one portafilter. For example, a first grinding cycle and a tamping operation is completed, the portafilter with coffee grounds delivered from the first grinding cycle is removed, reinserted without removing the coffee grounds delivered from the first grinding cycle and a second grinding cycle is performed again. This will also cause the same issue on the following grind cycle as using a single basket on the double basket setting.

To address the above problems, the above described system 200 can be used to check the dosage amount using the tamp mechanism 11 and a check can then be made of the calculated grinding time to determine if the grind cycle is relevant to the measured tamp depth, indicating an error in the basket setting. For example, the tamp depth will indicate a double basket is only half full if a single basket setting has been selected because a single basket is approximately half the grind volume of a double basket. An adjustment to the grind will depend on different scenarios as per the below table. A range would need to be set for when this applies to each scenario.

Grind for Single Basket Setting Selected & Double Basket Used

| Actual | Filter | Portafilter | | |
|---|---|---|---|---|
| basket | setting | Result | Correction | Auto effect |
| Double | Single | Severely | More grind | If New Grind |
| | | underdosed | | is |
| | | | | significantly |
| | | | | longer than |
| | | | | previous |
| | | | | grind (e.g. x |
| | | | | times), do |
| | | | | not update |
| | | | | the current |
| | | | | and/or next |
| | | | | grinding |
| | | | | time |

Grind for Double Basket Setting Selected & Single Basket Used

| Actual | Filter | Portafilter | | |
|---|---|---|---|---|
| basket | setting | Result | Correction | Auto effect |
| Single | Double | Severely | Remove excess | If New Grind |
| | | overdosed | coffee | is |
| | | | | significantly |
| | | | | less than |
| | | | | previous |
| | | | | grind (e.g. y |
| | | | | times), do |
| | | | | not update |
| | | | | the current |
| | | | | and/or next |
| | | | | grinding time |

This could be accompanied with a notification such as a Filter LED flashing or a Screen prompt to the user to advise of possible incorrect basket or filter setting selection.

Add more coffee grounds during a second grinding cycle
to a portafilter with a certain amount of coffee
grounds delivered from a first grinding cycle

| Actual | Filter | Portafilter | | |
|---|---|---|---|---|
| basket | setting | Result | Correction | Auto effect |
| a portafilter | Single or | Severely | Remove | If New Grind |
| with a | double | overdosed | excess coffee | is significant |
| certain | | | | less than previous |
| amount of | | | | grind (e.g. z |
| coffee | | | | times ± X seconds), |
| grounds | | | | do not update the |
| | | | | current and/or next |
| | | | | grinding time |

This could also be accompanied by some form of error flashing or a screen prompt.

### User Interface

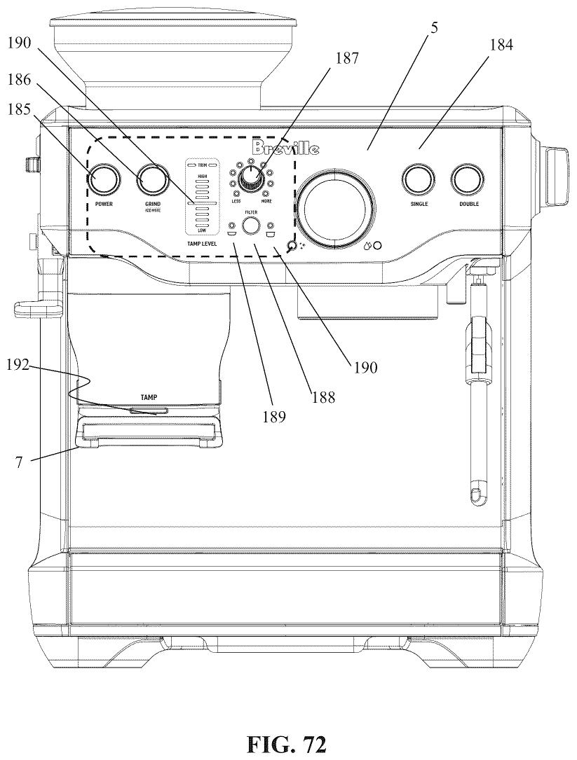

With regard to FIG. 72, an example of the user interface 184 is shown as including a panel 5 with a power button 185, a grind button 186 which is used to add additional coffee grounds to the current use in an underdosed situation, a dosage control dial 187 and a filter button 188 which may be pressed to toggle between filter basket sizes. A small basket icon 189 indicates a single dose basket is being used and a larger icon 190 indicates a double dose basket is being used. The panel 5 also includes an LED display 191 showing the coffee dosage in the basket. In addition, a tamp indicator 192 such as an LED may be provided above the portafilter holder 7 to indicate if a tamping operation is in progress.

Preferably, the controller 201 is configured to operate the tamp indicator 192 to illuminate in at least two states, for example a first state being a red colour and a second state being a green colour. The controller 201 is further preferably configured to operate the LED of the tamp indicator in a first state when the magnitude of the deviation is within the predetermined tolerance, and in a second state when the magnitude of the deviation is outside the predetermined tolerance.

If the deviation of the tamp depth from the predetermined ideal tamp depth exceeds a predetermined tolerance of, say, 0.5 mm the controller 201 provides information to the user interface 184 indicative of a polarity of the deviation. For example, the user interface 184 may display “overdose” or “underdose”, or correspondingly “increase grind” or “decrease grind”. Alternatively, the user interface 184 may display flavour-based feedback or adjustment settings, such as “weak”, “strong”, “perfect”. Alternatively, an indicator may indicate to the user how to adjust the grind to correct the deviation. For example, an LED may illuminate at the appropriate side of the dosage control dial or an LED on a button may flash to invite the user to press the button to add additional grind in an ‘underdose’ scenario.

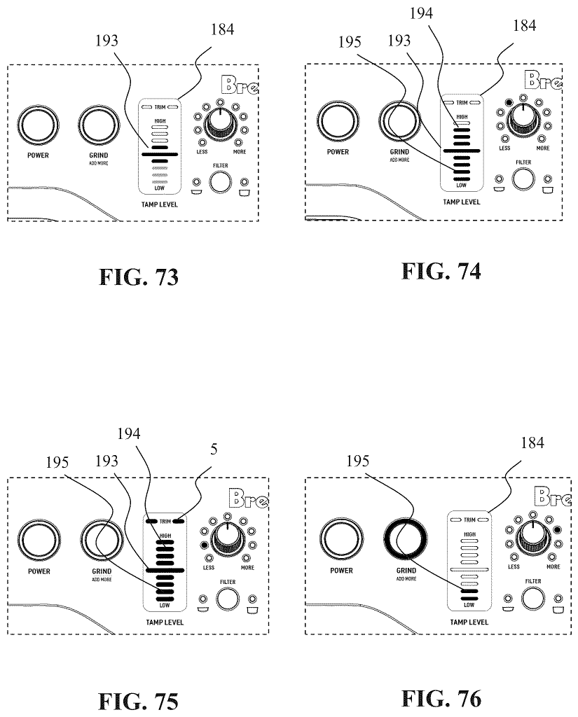

FIGS. 73 to 76 show LED illumination patterns which indicate various dosage conditions.

For example, if the deviation of the tamp depth does not exceed the predetermined tolerance, the controller 201 may cause one or more central LEDs 193 of the user interface 184 to be illuminated, as shown in FIG. 73 to indicate an acceptable dose. If the deviation exceeds the predetermined tolerance and the magnitude is positive, the controller 201 may cause one or more upper LEDs 194 to be illuminated, as shown in FIG. 74 to indicate an overdose.

If the deviation exceeds the predetermined tolerance by a predetermined threshold and the magnitude is positive, one or more upper LEDs 194, preferably also including the central LEDs 193 and one or more lower LEDs 195, of the indicator panel 5 to be illuminated and a warning LED 196, as shown in FIG. 75 to indicate that ground coffee should be removed from the portafilter. If the deviation exceeds the predetermined tolerance and the magnitude is negative, the processor 50 may cause the one or more of the lower LEDs 195 of the indicator to be illuminated, as shown in FIG. 76 to indicate an underdose.

### Machine Calibration

Due to manufacturing tolerances, the algorithm calculations will vary slightly between different machines. As a result, factory calibration will be required to account for this.

### Assumptions

All components have been correctly assembled
Measurements will only be taken if the lever 6 is at the end-stop (θ=0)

To calibrate the machine, different height plastic pucks are used. The plastic pucks may, for example, be −2 and +2 pucks, indicating the height of the pucks are at −2 mm deviation and +2 mm deviation height compared to the ideal tamp height. A measurement is taken on each of the pucks respectively to determine the relationship between the measurements obtained from the linear sensor 20 and the distance from ideal. This is known as the kinematic algorithm.

$$x = ( \frac{{x}_{1} - {x}_{2}}{{V}_{1} - {V}_{2}} ) \cdot ( V - {V}_{1} ) + {x}_{1}$$

x: distance from ideal
V: measurements obtained from the linear sensor 20

### Methodology

1. Hold for 5 seconds the ON button, Filter button and 2 cup Extraction button to enter factory calibration mode (although any pre-determined button combination can be chosen).
2. Place the −2 puck into the double basket and place the portafilter into the portafilter holder.
3. Tamp, hold the lever 6 at the end-stop until beep, then return lever 6 to home.
4. Place the +2 puck into the double basket and place the portafilter into the portafilter holder.
5. Tamp, hold the lever at the end-stop until beep, then return lever 6 to home.
6. After the lever 6 has been returned to home the unit will return to standby mode.

### Calculation

After taking the measurements with the −2 and +2 plastic pucks respectively, the unit will find the equation relating the sensor 20 to the distance from ideal.

$$x = ( \frac{{x}_{1} - {x}_{2}}{{V}_{1} - {V}_{2}} ) V - ( \frac{{x}_{1} - {x}_{2}}{{V}_{1} - {V}_{2}} ) {V}_{1} + {x}_{1}$$

To find the gradient solve for m,

$$m = ( \frac{{x}_{1} - {x}_{2}}{{V}_{1} - {V}_{2}} )$$

Next find the constant offset using the gradient and the two points,

$${C}_{4} = - m \cdot {V}_{1} + {x}_{1}$$

Substituting m and C₄ into x gives,

$$∴ x = m \cdot V + {C}_{4}$$

Therefore, the distance from ideal to the measured tamp height can be solved by two calibrated measurements. See the example that includes measurements obtained and solved below:

$$x = ( \frac{- 2 - 2}{5.6 - 1.6} ) V - ( \frac{- 2 - 2}{5.6 - 1.6} ) 5.6 + ( - 2 ) = - V + 5.6 - 2$$

$$x = 3. 6 - V$$

### User Calibration

Over the course of the machine's life, coffee may build up inside the rotating tamp which reduces the rotation and height variability of the tamp. This affects the dosage algorithm as the constants calculated during factory calibration are now different.

### Assumptions

All components have been correctly assembled.
Measurements will only be taken if the handle is at the end-stop (θ=0)
The gradient which relates the linear sensor 20 and the distance from ideal is the same regardless of the rotating tamp angle.
The rotating tamp may have reduced rotational angle, leading to the tamp height being variable between 0 to 3 mm

To perform a calibration one measurement is needed with the single walled, single basket inserted in the portafilter to determine the relationship between the measurements obtained from the linear sensor 20 and the distance from ideal. In this case, the kinematic algorithm is as follows.

$$x = m \cdot ( V - {V}_{1} ) + {x}_{1}$$

x: distance from ideal
V: measurements obtained from the linear sensor 20

### Methodology

1. Hold for 5 seconds the ON button & Filter button & 1 cup Extraction button to enter factory calibration mode, beeps for 1 sec (again, this can be any button combination).
2. Insert the single basket into the portafilter and place the portafilter into the portafilter holder.
3. Tamp, hold the tamp at the end-stop until beep, then return lever to home.
4. After the lever 6 has been returned to home the unit will return to standby mode, beeps for 1 sec.

### Calculation

Complete the single measurement as described in the methodology. Now the unit will find the equation relating the linear sensor 20 to the distance from ideal.

$$x - {x}_{1} = m \cdot ( V - {V}_{1} )$$

$$x = m \cdot ( V - {V}_{1} ) + {x}_{1}$$

$$x = m \cdot V - m \cdot {V}_{1} + {x}_{1}$$

From factory calibration assume the gradient is the same, for this example we will assume m=−1.
Next find the constant offset using the gradient and the two points, where the measured variable in this equation is V₁ which is recorded from the Linear sensor 20.

$${C}_{4} = - m \cdot {V}_{1} + {x}_{1}$$

$$3.6 = - ( - 1 ) \cdot ( 1.2 ) + ( 2.4 )$$

Substituting m and C₄ into x gives,

$$∴ x = m \cdot V + {C}_{4}$$

$$x = - 1 * V + 3.6$$

$$x = 3. 6 - V$$

Therefore, the distance from ideal to the measurements obtained from the sensor 20 can be solved by single calibrated measurement and constant gradient.

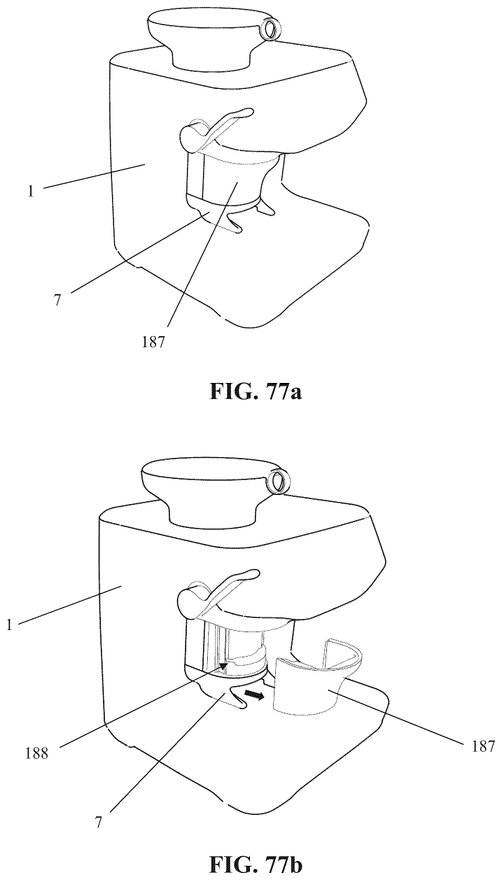

Referring lastly to FIGS. 77a and 77b, the machine includes a removable cover 187 over the tamping chute 188. The cover 187 allows a user to clean an internal area of the tamp chute 188. The cover 187 could also enrich the user experience so that the user can actually see real-time tamping motion. Further, the cover may help the user to understand how the tamping works and how they should operate the above described system 200 (e.g. apply suitable force to the handle at different locations) to obtain the best results. It may also help repairs to be conducted by allowing investigation of any potential issues (e.g. clogging) within the tamp chute 188 without pulling the whole machine 1 apart.

In a preferred embodiment, the cover is magnetically attached/removed immediately above the portafilter holder 7 via slide-in/out motion.

### Advantages

A number of advantages can be realised with the above described machine and tamping mechanism.

A rotary connection between the linkage and tamp allows the tamp to be rotated away from the grind chute at a top stroke of the mechanism, which means coffee grinds can be directed into the portafilter without obstruction. The grind chute can be located directly over the portafilter as a result, which optimises distribution into the portafilter as the grinds are delivered into a centralised pile, instead of being delivered from a sideward direction which might cause an uneven distribution of coffee in the resultant tamped off puck. By swinging the tamp out of the way of the chute, the chute can be located centrally without interfering with the tamp during a tamp operation.

Since the tamp mechanism rotates the tamp at the top of the stroke, instead of linearly lifting the tamp clear of the chute, the total height of the machine can be minimised.

The tamp mechanism preferably relies on an articulated linkage formed of hinged members which provides mechanical advantage whilst again minimising total height requirements of the machine. A large stroke length is achievable through the combined linkage lengths rather than a large pinion if a rack and pinion is used. This also allows a reduced rotation angle for the lever for compact implementation of the stroke length of the tamping mechanism without needing gearing.

The mechanism provides a good ‘handle feel’ to the lever due to the torque curve not being constant for a given load so the peak load occurs only at the end of stroke. This also improves mechanical advantage near the end of stroke at the detriment of force at the beginning of the stroke length. Maximum force is only required at an end stroke of the lever.

The rotary sensor associated with the lever and/or the linear sensor detects the lever position and/or the tamp position which can be displayed on a under interface. The user interface can also provide possible next steps such that the users can be instructed/taught to make a cup of coffee.

A grind switch can be activated by lifting (rotating) the lever from its home position to start the grinder. The movements of the lever and the piston can either be manual or motorised.

The tamping force control assembly provides a bias force to assist with tamping which means a low compression distance is required making the design more compact. The pre-tensioning also means a lower spring rate spring can be used that gives a more consistent force over the compression distance.

By measuring the compression of the tamping force control assembly and/or the shaft rotation, the tamp depth can be calculated which can in turn be used to adjust the dosage. The machine can provide user feedback of the dosage through the user interface. This tamp depth can then also be used to calculate the optimum grind for the correct dosage. If underdosed, the grind can be increased. In the case of an overdose, the next grind can be reduced automatically or be displayed to the user for manual adjustment.

A manual grind mode can be implemented if the user lifts the lever for a pre-determined time. By lifting the lever, the user activates a grinder switch to start the grinder—this mode allows user to manually control the grind amount.

The portafilter can slide into the portafilter holder where it is centrally located by spring clips. It is possible also to activate a button to start the grinder. The portafilter is supported on the portafilter bayonets one of which may be supported by the button itself. The push in design allows easier insertion and reduces the clearance required under the portafilter holder for insertion if vertical fit is used.

By enclosing the tamping mechanism in a housing coffee grounds can be contained, and resultant mess drastically reduced.

The ‘handle feel’ may be improved over a rack and pinion design and the required force to tamp grinds may also be reduced over a rack and pinion with the same angle of lever rotation.

The spring preload of the tamping force control assembly is suitable for applying and controlling the tamp force over different dosage levels without the user judging the handle force.

Dosage feedback of the tamp depth or puck height is possible electronically.

Calculation of the optimal grind and “a bit more” amount is possible using electronic measurement of the puck height.

The portafilter holder design allows the portafilter to be simply slid into the portafilter holder as opposed to being lifted and rotated, as required for conventional bayonet connection. This provides an improved user experience.

List of Parts

| | |
|---|---|
| 1. | Machine |
| 2. | Tamping unit |
| 3. | Hopper |
| 4. | Casing |
| 5. | User interface panel |
| 6. | Lever |
| 7. | Portafilter holder |
| 8. | Drip tray |
| 9. | Dial |
| 10. | Grinder |
| 11. | Tamping mechanism |
| 12. | Shaft |
| 13. | Actuator |
| 14. | Tamp |
| 15. | Tamping force control assembly |
| 16. | Piston |
| 17. | Biasing element |
| 18. | Spring |
| 19. | Connecting rod |
| 20. | Sensor |
| 21. | Grind chute |
| 22. | Flow path |
| 23. | Exit |
| 24. | Centreline |
| 25. | Face |
| 26. | End |
| 27. | Base |
| 28. | Body |
| 29. | Coupler |
| 30. | Linkage |
| 31. | End |
| 32. | Coupling |
| 33. | Housing |
| 34. | Guide Structure |
| 35. | Slots |
| 36. | First member |
| 37. | Second member |
| 38. | Notch |
| 39. | |
| 40. | Portafilter |
| 41. | Switch |
| 42. | Basket |
| 43. | Lower end |
| 44. | Limited movement connection |
| 45. | Upper end |
| 46. | Section |
| 47. | Return device |
| 48. | Tension spring |
| 49. | Fixed mount |
| 50. | Control gear |
| 51. | Rotary position sensor |
| 52. | Cog |
| 53. | Damper |
| 54. | Cog |
| 55. | Pivot |
| 56. | Slot |
| 57. | End |
| 58. | Crosspiece |
| 59. | PCB |
| 60. | Clutch |
| 61. | Hub |
| 62. | Protrusion |
| 63. | Grinder activation switch |
| 64. | Springs |
| 65. | Posts |
| 66. | Fixed structure |
| 67. | End washers |
| 68. | Carriage |
| 69. | U-shaped section |
| 70. | Extension |
| 71. | Limited movement connector |
| 72. | Rocker |
| 73. | Pivot |
| 74. | End of rocker |
| 75. | End of rocker |
| 76. | Elongate opening |
| 77. | Follower |
| 78. | Channel |
| 79. | Bracket |
| 80. | Upper end |
| 81. | Lower end |
| 82. | Pivot |
| 83. | Coffee |
| 84. | Puck |
| 85. | Rack |
| 86. | Fixed arm |
| 87. | Leg |
| 88. | Crossbeam |
| 89. | Teeth |
| 90. | Pinion |
| 91. | Slot |
| 92. | Rollers |
| 93. | Beam |
| 94. | Base |
| 95. | Lower end |
| 96. | Top |
| 97. | Vertical part |
| 98. | Curved top part |
| 99. | Remote end |
| 100. | Gear section |
| 101. | Intermediate gear |
| 102. | Rod |
| 103. | Drive shaft |
| 104. | Support |
| 105. | Second linkage |
| 106. | Tamp body |
| 107. | Side portion |
| 108. | Clearance space |
| 109. | Annular slot |
| 110. | Pin |
| 111. | Arrow |
| 112. | First disc |
| 113. | Connection members |
| 114. | Biased elements |
| 115. | Second disc |
| 116. | Connection recesses |
| 117. | Biased elements |
| 118. | Clutch disc |
| 119. | Clamp |
| 120. | Annular slots |
| 121. | Openings |
| 122. | Support Structure |
| 123. | Transverse pin |
| 124. | Support member |
| 125. | Rotating mechanism |
| 126. | Collar |
| 127. | Cylinder |
| 128. | Screw |
| 129. | Biasing element |
| 130. | Spring |
| 131. | Cam structure |
| 132. | Ramps |
| 133. | Projections |
| 134. | Side wall |
| 135. | Outer wall |
| 136. | Flange |
| 137. | Seal |
| 138. | Retaining ring |
| 139. | Rebate |
| 140. | Skirt |
| 141. | Ferrules |
| 142. | Axles |
| 143. | Axles |
| 144. | Openings |
| 145. | Circlips |
| 146. | Ferrules |
| 147. | Rubber seal |
| 148. | Inner ring |
| 149. | Base cover |
| 150. | Shoulder |
| 151. | Annular groove |
| 152. | Wiper blade |
| 153. | Track |
| 154. | Track |
| 155. | Lower portion |
| 156. | Upper portion |
| 157. | Upper portion |
| 158. | Centre line |
| 159. | Vertical line |
| 160. | Spring |
| 161. | Teeth |
| 162. | Section |
| 163. | Handle |
| 164. | Cup portion |
| 165. | Locating tabs |
| 166. | Rim |
| 167. | Access opening |
| 168. | Dock |
| 169. | Support surface |
| 170. | Support surface |
| 171. | Ramp |
| 171a. | Support Surface |
| 172. | Clasp |
| 173. | Biased element |
| 174. | Spring clip |
| 175. | Horizontal line |
| 176. | End wall |
| 177. | Opening |
| 178. | Recess |
| 179. | Underside |
| 180. | Body |
| 181. | Inner profile |
| 182. | Tang |
| 183. | Fastener |
| 184. | Sensor |
| 185. | Sensor |
| 186. | Sensor |
| 187. | Removable cover |
| 188. | Tamp chute |
| 200. | System |
| 201. | Controller |
| 202. | Grinder module |
| 203. | Tamper module |
| 204. | User interface module |
| 210. | Centre |
| 211. | Filter cup |
| 212. | Centre axis |
| 213. | Retention member |
| 214. | Centre |
| 215. | Filter cup floor |
| 216. | Switch |
| 217. | Central axis |
| 218. | Connecting assembly |
| 219. | First inclined surface |
| 220. | Cam |
| 221. | Second inclined surface |
| 222. | Bias member |
| 223. | Stop member |
| 224. | Indicator |
| 225. | Tabs |
| 226. | Pin |

1. A method of delivering coffee grounds into a portafilter fitted to a machine for grinding coffee including determining a pre-determined grind to provide the coffee grounds, applying a tamp to form the coffee grounds into a puck, and providing tamp position feedback to a user during and/or after a tamping operation.

2. The method of claim 1, including monitoring tamp depth.

3. The method of claim 2, including informing the user if any adjustment to the grind is needed.

4. The method of claim 3, further including determining if the tamp depth is within a predetermined tolerance and adjusting a grind time if the tamp depth is outside the pre-determined tolerance.

5. The method of claim 2, further including determining deviation of the tamp depth, if outside the pre-determined tolerance, providing information to a user through a user interface of tamp depth deviation, together with deviation polarity.

6. The method of claim 1, including providing user prompts through the user interface to adjust grind time manually.

7. The method of claim 6, further including monitoring a status of a hopper, grinder motor and portafilter and turning the grinder off if the hopper is empty, the grinder is blocked or the portafilter is not present.

8. The method of claim 7, further including recording the actual grind time if the grinder motor is turned off and updating the grind time for a subsequent grind to include a time required to complete a grinding operation when the grinder is again turned on.

9. The method of claim 8, further including notifying a user of the hopper, grinder motor and portafilter status through a user interface and notifying the user of the updated grind time.

10. The method of claim 1, further including determining if an incorrect basket size has been selected by the user by measuring the tamp depth to assess if the tamp depth is in a range that correlates with an expected tamp depth for the selected basket size.

11. The method of claim 10, including notifying a user through the user interface if the determination is an incorrect basket size has been entered by the user and updating the grind time to reflect a correct basket size selection.

12. The method of claim 1, including calibrating the machine using pucks of known heights set to the pre-determined tolerances, conducting a tamping operation and checking if the tamp position correlates to the known puck heights and making any calibration adjustments, if needed.

13. The method of claim 12, including calibrating the tamp including conducting a tamp operation on a single puck of ideal puck height, checking the tamp position and making calibration adjustments, if needed.

14. A system for implementing the method of claim 1, including:
a controller;
a tamper module to conduct a tamping operation and provide tamp position information to the controller; and
a user interface module to facilitate user operation of the system, the interface module providing the user with operational prompts and allowing for the user to operate the grinder and conduct a tamping operation.

15. The system of claim 14, further including a motor status sensor, which provides information on either the current or the motor speed of the grinder, to indicate the presence of beans in the hopper and/or blockages.

16. The system of claim 14, further including a grinder module which receives start and stop signals from the controller and provides feedback to the controller when the grind is complete.

17. A system including:
a controller;
a grinder module which receives start and stop signals from the controller and provides feedback to the controller when the grind is complete;
a tamper module to conduct a tamping operation and provide tamp position information to the controller; and
a user interface module to facilitate user operation of the system, the interface module providing the user with operational prompts and allowing for the user to operate the grinder and conduct a tamping operation, wherein the system is configured to monitor tamp depth.

18. The system of claim 17, further including a motor status sensor, which provides information on either a current or a motor speed of a coffee grinder, to indicate the presence of beans in the hopper and/or blockages.

19. The system of claim 17, configured to determine if the tamp depth is within a predetermined tolerance and adjust a grind time if the tamp depth is outside the pre-determined tolerance.

20. The system of claim 14, wherein the system determines deviation of the tamp depth, and if outside the pre-determined tolerance, provides information to a user through a user interface of tamp depth deviation, together with deviation polarity.

21.-28. (canceled)
